(19) United States
(12) Patent Application Publication
(10) Pub. No.: US 2011/0279901 A1
(43) Pub. Date: Nov. 17, 2011

(54) MULTILAYER FILTER AND FLUORESCENT MICROSCOPE USING THE SAME

(75) Inventor: Tadashi WATANABE, Kamiina (JP)

(73) Assignee: OLYMPUS CORPORATION, Tokyo (JP)

(21) Appl. No.: 13/102,189

(22) Filed: May 6, 2011

(30) Foreign Application Priority Data
May 14, 2010 (JP) 2010-111931

(51) Int. Cl. G02B 5/28

(52) U.S. Cl. 359/589

(57) ABSTRACT

A multilayer filter includes a multilayer part in which a layer composed of a first material and a layer composed of a second material having a refractive index different from that of the first material are stacked in an alternating pattern. The multilayer part has a cyclic film-thickness structure in which three or more layers are defined as one cycle.

### CROSS REFERENCE TO RELATED APPLICATIONS

This application is based upon and claims the benefit of priority from prior Japanese Patent Application No. 2010-111931, filed May 14, 2010, the entire contents of which are incorporated herein by this reference.

### BACKGROUND OF THE INVENTION

1. Field of the Invention

The present invention relates to a multilayer filter and a fluorescent microscope using it.

2. Description of the Related Art

Fluorescence detected in a fluorescence observation is generally weak in comparison with excitation light, and hence, in a fluorescent microscope, fluorescence is efficiently separated from excitation light using a frequency difference. For this separation, an optical filter such as a minus filter or a dichroic mirror is used. Accordingly, the optical filter is an important optical element that influences the performance of a fluorescent microscope.

A multilayer structure in which thin films of different refractive indexes are stacked is known to achieve various optical characteristics via transmitted light and reflection light generated at the borders between the layers interfering with each other, and hence this structure is suitable as the optical filter above. Accordingly, optical filters which achieve various optical characteristics using a multilayer structure (hereinafter referred to as “multilayer filters”) have conventionally been proposed.

The performance of the optical filters has been improved as indicated above; however, more improvements in the optical filters have been required. As an example, the following are required for minus filters.

In recent molecular biology studies, the need to be able to observe dynamic behaviors of live cells has been growing, and hence, in addition to light used for exciting or observing fluorescent materials, light for manipulating the cells (hereinafter referred to as “manipulation light”) and light for stimulating the cells so as to see their reactions (hereinafter referred to as “stimulation light”) is sometimes used. In such a case, a minus filter which blocks manipulation light and stimulation light and efficiently allows passage of light of other wavelengths is required.

In a similar field, meanwhile, there is also a need for simultaneously detecting a plurality of kinds of fluorescence by using light of a plurality of wavelengths to excite a fluorescent material so as to correctly observe interactions in the cell and the placement of a plurality of observation objects. In such a case, a minus filter which efficiently allows passage of both wavelengths shorter than the excitation light and wavelengths longer than the excitation light while blocking the excitation light is also required.

In both cases, a minus filter is required to block or reflect light within a wavelength range (hereinafter referred to as “a reflection band”) which is sufficiently narrow.

In addition, recently, demand for minus filters in industrial technology has also increased, such as in the fields of optical communication, illumination, and display. This relates to the fact that LEDs and lasers having a narrow emission wavelength range are widely used as light sources for various industrial instruments. Accordingly, in various fields of industrial technology in which these light sources are used, minus filters which block only narrow wavelength ranges from these light sources or which adjust transmittance are also needed.

In order to meet these requirements, the following multilayer filters functioning as minus filters are proposed.

Japanese Laid-open Patent Publication No. 2002-319727 discloses a multilayer filter in which two materials having a difference in refractive index are stacked. Via the refractive-index difference between the two materials being made small, the multilayer filter disclosed in Japanese Laid-open Patent Publication No. 2002-319727 functions as a minus filter having a narrow reflection band.

Japanese Laid-open Patent Publication No. 2003-215332 discloses a multilayer filter in which dielectric thin films having a relatively high refractive index and dielectric thin films having a relatively low refractive index are stacked in an alternating pattern. By using a high order reflection (mainly, a tertiary reflection) caused by equalizing the optical thicknesses of the two kinds of dielectric thin films, the multilayer filter disclosed in Japanese Laid-open Patent Publication No. 2003-215332 functions as a minus filter having a narrow reflection band.

Japanese Laid-open Patent Publication No. 2006-023471 discloses a multilayer filter in which high refractive index layers and low refractive index layers are stacked in an alternating pattern. The multilayer filter disclosed in Japanese Laid-open Patent Publication No. 2006-023471 is similar to the ones in Japanese Laid-open Patent Publication No. 2002-319727 and Japanese Laid-open Patent Publication No. 2003-215332 in the sense that materials having different refractive indexes are stacked. However, by using a secondary reflection band formed by making the optical film thickness of low refractive index layers and the optical film thickness of high refractive index layers to be different from each other, the multilayer filter disclosed in Japanese Laid-open Patent Publication No. 2006-023471 functions as a minus filter having a narrow reflection band.

Japanese Laid-open Patent Publication No. 2006-085041 discloses a multilayer filter in which thin films composed of materials having various refractive indexes are stacked. The multilayer filter disclosed in Japanese Laid-open Patent Publication No. 2006-085041 functions as a minus filter which has a wide transmission band in addition to a narrow reflection band.

### SUMMARY OF THE INVENTION

One aspect of the present invention provides a multilayer filter including a multilayer part in which a layer composed of a first material and a layer composed of a second material having a difference in refractive index from that of the first material are stacked in an alternating pattern, wherein the multilayer part has a cyclic film-thickness structure in which three or more layers are defined as one cycle.

### BRIEF DESCRIPTION OF THE DRAWINGS

The present invention will be more apparent from the following detailed description when the accompanying drawings are referenced.

FIG. 1 is a diagram illustrating a spectral transmittance characteristic of a multilayer filter according to a prior art.

FIG. 2 is a diagram illustrating a spectral transmittance characteristic of a multilayer filter including a multilayer part that has a cyclic film-thickness structure in which three layers are defined as one cycle.

FIG. 3 is a diagram illustrating a spectral transmittance characteristic of a multilayer filter including a multilayer part that has a cyclic film-thickness structure in which four layers are defined as one cycle.

FIG. 4 is a diagram illustrating a spectral transmittance characteristic of a multilayer filter including a multilayer part that has a cyclic film-thickness structure in which five layers are defined as one cycle.

FIG. 5 is a diagram illustrating a spectral transmittance characteristic of a multilayer filter including a multilayer part that has a cyclic film-thickness structure in which six layers are defined as one cycle.

FIG. 6 is a diagram illustrating relationships between a film-thickness difference and a reflectivity and between a film-thickness difference and a reflection band width in a multilayer filter including a multilayer part that has a cyclic film-thickness structure in which four layers are defined as one cycle.

FIG. 7 is a diagram illustrating a relationship between the number of stacked basic configurations and a reflectivity in a multilayer filter including a multilayer part that has a cyclic film-thickness structure in which three layers are defined as one cycle.

FIG. 8 is a diagram illustrating a relationship between a ripple-generation pattern and film thickness settings of all layers included in a basic configuration in a multilayer filter including a multilayer part that has a cyclic film-thickness structure in which four layers are defined as one cycle.

FIG. 9 is a diagram illustrating a spectral transmittance characteristic of a multilayer filter including a multilayer part that has a cyclic film-thickness structure in which three layers are defined as one cycle, and a spectral transmittance characteristic of a multilayer filter including a multilayer part that has a cyclic film-thickness structure in which four layers are defined as one cycle.

FIG. 10 is a diagram illustrating a spectral transmittance characteristic of a multilayer filter including a multilayer part that has a cyclic film-thickness structure in which three layers are defined as one cycle, and spectral transmittance characteristics of two multilayer filters according to a prior art.

FIG. 11A is a schematic view showing a configuration of a multilayer filter according to embodiment 1.

FIG. 11B is a schematic view showing a basic configuration for configuring a multilayer part included in the multilayer filter shown in FIG. 11A.

FIG. 12 is a diagram showing a spectral transmittance characteristic of the multilayer filter according to embodiment 1.

FIG. 13 is a diagram showing a spectral transmittance characteristic of a multilayer filter according to embodiment 2.

FIG. 14 is a diagram showing a spectral transmittance characteristic of a multilayer filter according to embodiment 3.

FIG. 15 is a diagram showing a spectral transmittance characteristic of a multilayer filter according to embodiment 4.

FIG. 16 is a diagram showing a spectral transmittance characteristic of a multilayer filter according to a prior art.

FIG. 17 is a diagram showing a spectral transmittance characteristic of a multilayer filter according to embodiment 5 with respect to vertical incident light.

FIG. 18 is a diagram showing a spectral transmittance characteristic of the multilayer filter according to embodiment 5 with respect to oblique incident light.

FIG. 19 is a diagram showing a spectral transmittance characteristic of a multilayer filter according to embodiment 6 with respect to vertical incident light.

FIG. 20 is a diagram showing a spectral transmittance characteristic of the multilayer filter according to embodiment 6 with respect to oblique incident light.

FIG. 21A is a schematic view showing a configuration of a multilayer filter according to embodiment 7.

FIG. 21B is a schematic view showing a basic configuration for configuring a multilayer part included in the multilayer filter shown in FIG. 21A.

FIG. 22 is a diagram showing a spectral transmittance characteristic of the multilayer filter according to embodiment 7.

FIG. 23 is a diagram showing a spectral transmittance characteristic of a multilayer filter according to embodiment 8.

FIG. 24 is a diagram showing a spectral transmittance characteristic of a multilayer filter according to embodiment 9 with respect to vertical incident light.

FIG. 25 is a diagram showing a spectral transmittance characteristic of the multilayer filter according to embodiment 9 with respect to oblique incident light.

FIG. 26 is a diagram showing, for a number of incident angles, spectral transmittance characteristics of the multilayer filter according to embodiment 9.

FIG. 27 is a diagram showing a spectral transmittance characteristic of a multilayer filter according to embodiment 10 with respect to oblique incident light.

FIG. 28 is a diagram showing a spectral transmittance characteristic of an optical component according to embodiment 11 with respect to vertical incident light.

FIG. 29 is a diagram showing a spectral transmittance characteristic of an optical component according to embodiment 11 with respect to incident light forming a 30° incident angle.

FIG. 30 is a diagram showing a spectral transmittance characteristic of the optical component according to embodiment 11 with respect to incident light forming a 45° incident angle.

FIG. 31 is a diagram showing a spectral transmittance characteristic of the optical component according to embodiment 11 with respect to incident light forming a 60° incident angle.

FIG. 32 is a schematic view showing a configuration of a fluorescent microscope according to embodiment 12 including a multilayer filter.

FIG. 33A is a diagram showing spectral transmittance characteristics of a plurality of multilayer filters which together function as a bandpass filter.

FIG. 33B is a diagram showing spectral transmittance characteristics of a plurality of multilayer filters which together function as a bandpass filter.

FIG. 34 is a schematic view showing a configuration of a fluorescent microscope according to embodiment 13 including a multilayer filter.

FIG. 35 is a schematic view showing a configuration of a fluorescent microscope according to embodiment 14 including a multilayer filter.

FIG. 36 is a schematic view showing a configuration of a fluorescent microscope according to embodiment 15 including a multilayer filter.

### DESCRIPTION OF THE PREFERRED EMBODIMENTS

First, in order to clarify characteristics of multilayer filters according to embodiments described later, outlines will be given regarding the configuration of a multilayer filter according to a prior art and regarding a reflection band formed in the prior art.

A multilayer filter according to the prior art includes a multilayer part in which two materials having different refractive indexes are stacked in an alternating pattern, wherein the multilayer part has a cyclic film-thickness structure in which two layers are defined as one cycle. A cyclic film-thickness structure in which two layers are defined as one cycle indicates a structure in which the film thickness cyclically changes in each cycle composed of two layers. In other words, the refractive index cycle and the thin film cycle are both two layers, and a multilayer part is a structure in which basic configurations each composed of two layers are stacked.

A reflection band formed in such a multilayer filter and the behavior of the reflection band are disclosed and described in detail in, for example, document 1 (Alfred Thelen/Design of Optical Interference Coatings/McGraw-Hill Book Company (1989)), document 2 (Ronald R. Willey/Practical Design and Production of Optical Thin Films/Marcel Dekker, Inc. (2002)), document 3 (Philip W. Baumeister/Optical Coating Technology/SPIE Press (2004)), and the like.

The following two points are clarified in the documents above.

First, it is indicated that, in a multilayer filter (QWOT Stack) in which each layer has a film thickness corresponding to ¼ of an optional wavelength λ (QWOT: quarter-wave optical thickness) and in which layers composed of a first material and layers composed of a second material having a difference in refractive index from that of the first material are stacked in an alternating pattern, a reflection band around the wavelength λ is formed. The reflection band is also called a Block Band. The reflectivity of the reflection band becomes higher as the number of stacked basic configurations each composed of the two kinds of stacked materials increases. As the refractive-index difference between the layer composed of the first material and the layer composed of the second material becomes larger, the reflectivity becomes higher and the width of the reflection band becomes wider. Meanwhile, as the refractive-index difference becomes smaller, the reflectivity becomes lower and the width of the reflection band becomes narrower.

Second, it is indicated that, in a multilayer filter in which each layer has a film thickness corresponding to ¼ of an optional wavelength λ and in which layers composed of a first material and layers composed of a second material are stacked in an alternating pattern, a reflection band may also be formed in the wavelength range of a wavelength which is the wavelength λ divided by an integer. The aforementioned reflection band formed around the wavelength λ is called a main reflection band, and the reflection band formed in the wavelength range of a wavelength which is the wavelength λ divided by an integer is called a high order reflection band. In particular, from among high order reflection bands, a reflection band formed in the wavelength range at λ/2 is called a second-order reflection band, a reflection band formed in the wavelength range at λ/3 is called a third-order reflection band, and a reflection band formed in the wavelength range at λ/n (n is an integer) is called an n-th order reflection band.

In other words, as a prior art, a multilayer filter having a multilayer part in which basic configurations each composed of two layers are stacked is known, and it is known that a main reflection band and its high order reflection band can be formed. Meanwhile, a reflection band formed at a longer wavelength than the main reflection band is not known. In addition, a high order reflection band formed in a wavelength range other than a wavelength range which is the main reflection band divided by an integer is not known either.

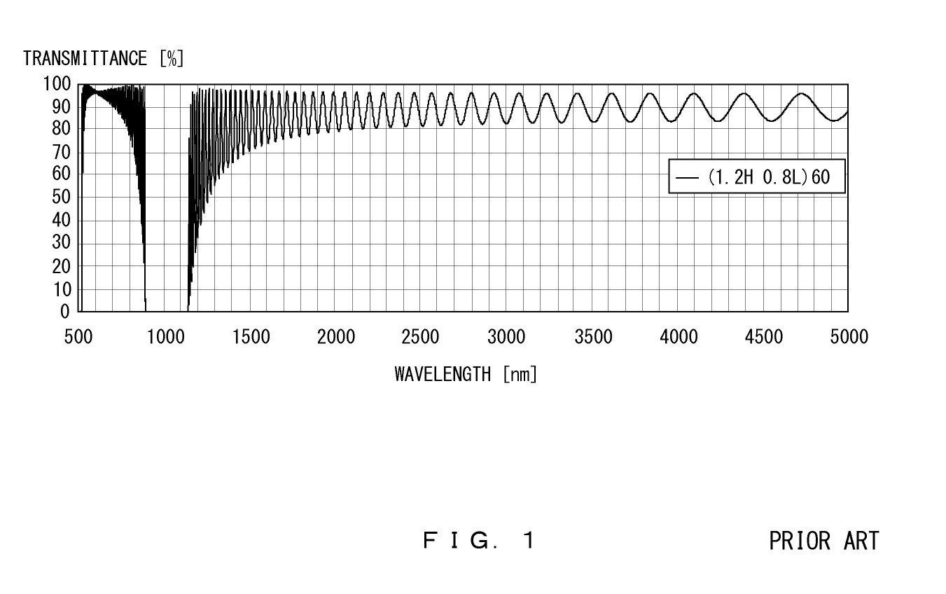

FIG. 1 is a diagram illustrating a spectral transmittance characteristic of a multilayer filter according to a prior art. A multilayer filter 100 having a characteristic illustrated in FIG. 1 is a multilayer filter including a multilayer part in which the aforementioned basic configurations each composed of two layers are stacked, and has the following film configuration. Multilayer filter 100

Substrate/(1.2H 0.8L) 60/Air

The stacked layers in the notation above are ordered so that the layer closest to the substrate comes first. H and L indicate a high refractive index layer (hereinafter referred to as an H layer) and a low refractive index layer (hereinafter referred to as an L layer), respectively. The numeric values to the left of H and L indicate optical film thicknesses at a design standard wavelength λ₀, and the optical film thickness corresponding to λ₀/4 is represented as 1. The points within parentheses indicate a basic configuration, and the numeric value to the right of the parentheses indicates the number of stacked basic configurations.

The design standard wavelength λ₀ of the multilayer filter 100 and the refractive indexes n_{H}, n_{L}, n_{S}, and n_{A} of the H layer, the L layer, the substrate, and air are as follows.

λ₀=1000 nm, n_{H}=2.2, n_{L}=1.46, n_{S}=1.52, n_{A}=1.0

As illustrated in FIG. 1, the multilayer filter 100 according to the prior art has a main reflection band formed around 1000 nm and a second order reflection band formed in a wavelength range of ½×1000 nm (500 nm). A reflection band having a longer wavelength than the main reflection band is not provided. Since the average optical film thickness of the two layers in the basic configuration is ¼ of the design standard wavelength λ₀, the wavelength at which the main reflection band is formed (hereinafter referred to as a main reflection wavelength λ_{M}) and the design standard wavelength λ₀ are identical with each other in FIG. 1. However, since the design standard wavelength λ₀ may be optionally selected, they are not always identical with each other.

As described above, since the main reflection band has a small reflection band width selectivity, a reflection band width cannot be optionally obtained. As a result, when the main reflection band is used, the multilayer filter 100 does not sufficiently function as a minus filter having a narrow reflection band. In addition, when a second order reflection band is used, the multilayer filter 100 does not sufficiently function as a minus filter having a wide transmission band since the interval in the multilayer filter 100 between adjacent reflection bands (i.e., between the main reflection band and a third order reflection band not shown) is small.

Therefore, the multilayer filter according to the prior art illustrated in FIG. 1 does not function as a minus filter having a small reflection band and a wide transmission band.

Next, outlines will be given regarding the configurations of multilayer filters according to embodiments and regarding reflection bands formed in the embodiments.

All multilayer filters according to the embodiments include a multilayer part in which two materials having different refractive indexes are stacked in an alternating pattern, wherein the multilayer part has a cyclic film-thickness structure in which three or more layers are defined as one cycle. In other words, the refractive index cycle and the thin film cycle are not identical with each other, and the multilayer part is a structure in which basic configurations each composed of three or more layers (equal to the least common multiple of the refractive index cycle and the thin film cycle) are stacked.

More particularly, a multilayer part having a cyclic film-thickness structure in which three layers are defined as one cycle (hereinafter, the multilayer part will be referred to as a T3 multilayer part and its film-thickness structure will be referred to as a T3 film-thickness structure) is a structure in which basic configurations each composed of six layers (=3×2) are stacked. A multilayer part having a cyclic film-thickness structure in which four layers, five layers, or six layers are defined as one cycle (hereinafter, the multilayer parts will be respectively referred to as a T4 multilayer part, a T5 multilayer part, and a T6 multilayer part, and their film-thickness structures will be respectively referred to as a T4 film-thickness structure, a T5 film-thickness structure, and a T6 film-thickness structure) is a structure in which basic configurations each composed of four layers (the least common multiple of 4 and 2), ten layers (the least common multiple of 5 and 2), or six layers (the least common multiple of 6 and 2) are stacked.

As a result of many studies in design, the inventors found that, in accordance with the structures above, it is possible to form reflection bands (hereinafter referred to as new reflection bands) other than the reflection bands formed by multilayer filters according to the prior art. In addition, as a result of studies of properties of the new reflection bands, it was found that the new reflection bands have many industrially valuable properties.

Hereinafter, reflection bands respectively formed by a multilayer filter 1 including the T3 multilayer part, a multilayer filter 2 including the T4 multilayer part, a multilayer filter 3 including the T5 multilayer part, and a multilayer filter 4 including the T6 multilayer part will be specifically described.

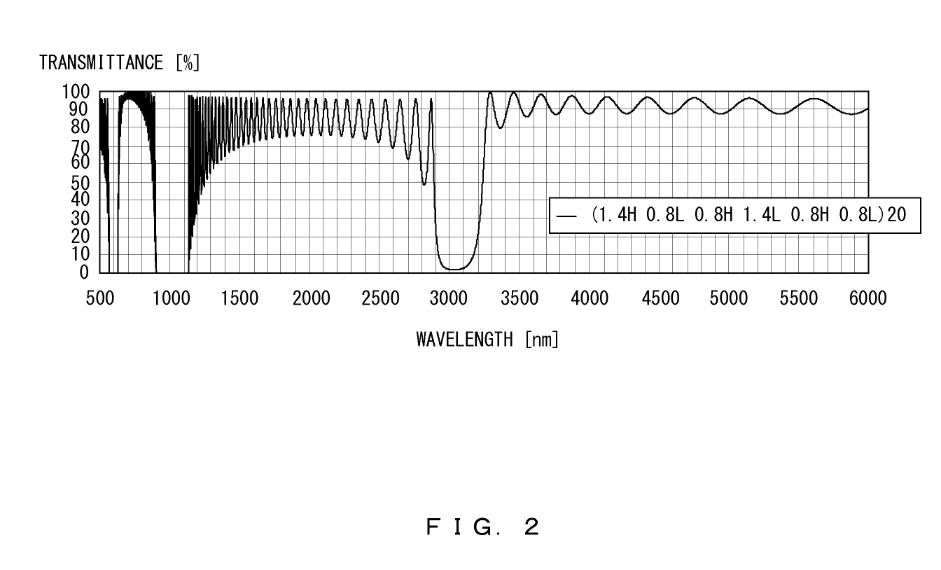

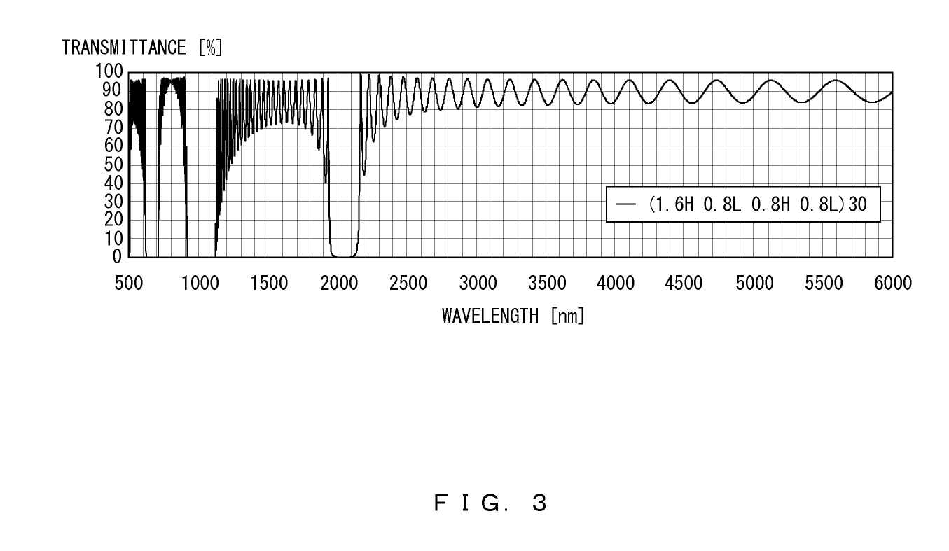

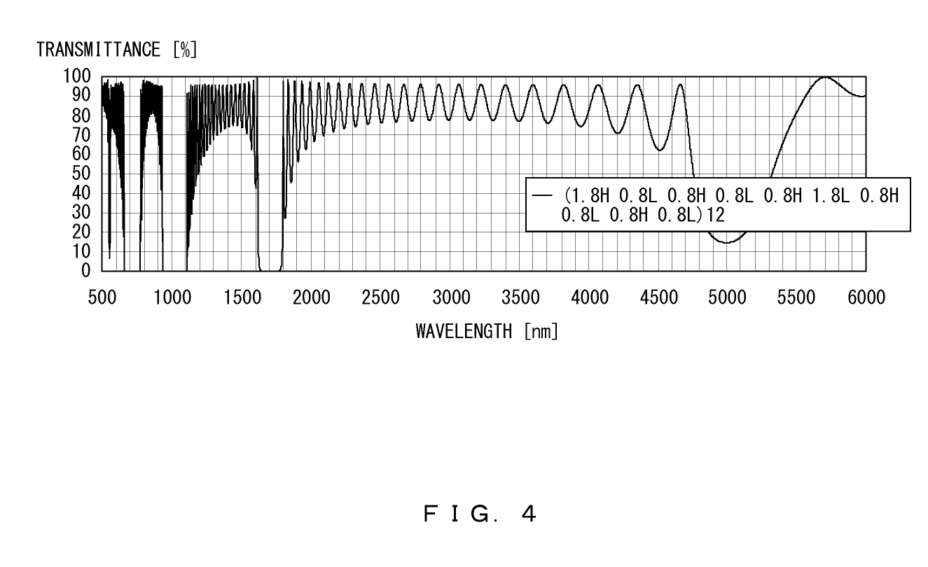

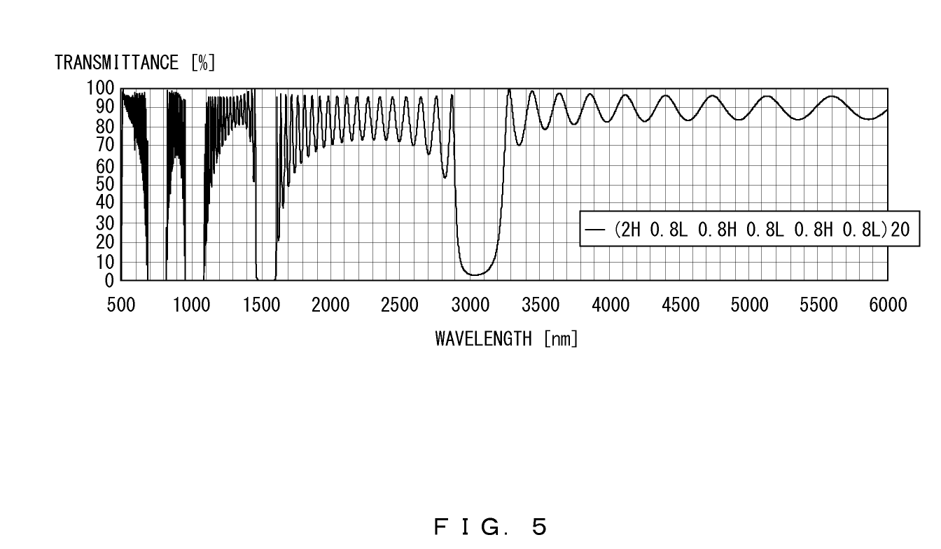

FIG. 2 is a diagram illustrating a spectral transmittance characteristic of the multilayer filter 1 including the T3 multilayer part. FIG. 3 is a diagram illustrating a spectral transmittance characteristic of the multilayer filter 2 including the T4 multilayer part. FIG. 4 is a diagram illustrating a spectral transmittance characteristic of the multilayer filter 3 including the T5 multilayer part. FIG. 5 is a diagram illustrating a spectral transmittance characteristic of the multilayer filter 4 including the T6 multilayer part.

The film configurations of the multilayer filter 1, the multilayer filter 2, the multilayer filter 3, and the multilayer filter 4 are as follows. Basic configurations composed of six layers, four layers, ten layers, and six layers are respectively indicated for the multilayer filters.

Multilayer filter 1

Substrate/(1.4H 0.8L 0.8H 1.4L 0.8H 0.8L) 20/Air

Multilayer filter 2

Substrate/(1.6H 0.8L 0.8H 0.8L) 30/Air

Multilayer filter 3

Substrate/(1.8H 0.8L 0.8H 0.8L 0.8H 1.8L 0.8H 0.8L 0.8H 0.8L) 12/Air

Multilayer filter 4

Substrate/(2H 0.8L 0.8H 0.8L 0.8H 0.8L) 20/Air

The design standard wavelength λ₀ and the refractive indexes n_{H}, n_{L}, n_{S}, and n_{A} of the H layer, the L layer, the substrate, and air in all the multilayer filters of the configurations above are as follows.

λ₀=1000 nm, n_{H}=2.2, n_{L}=1.46, n_{S}=1.52, n_{A}=1.0

In all the basic configurations, the average film thickness of the layers is 1, which is ¼ of the design standard wavelength λ₀, and hence the main reflection wavelength λ_{M} is also 1000 nm.

As illustrated in FIG. 2, the multilayer filter 1 including the T3 multilayer part has a main reflection band formed around 1000 nm (=λ_{M}=λ₀) as well as a new reflection band formed in a wavelength range at a wavelength which is three times the main reflection wavelength λ_{M} and a new reflection band formed in a wavelength range at a wavelength which is ⅗ the main reflection wavelength λ_{M}.

As illustrated in FIG. 3, the multilayer filter 2 including the T4 multilayer part has a main reflection band formed around 1000 nm (=λ_{M}=λ₀) as well as a new reflection band formed in a wavelength range at a wavelength which is twice the main reflection wavelength λ_{M}, and a new reflection band formed in a wavelength range at a wavelength which is ⅔ the main reflection wavelength λ_{M}.

As illustrated in FIG. 4, the multilayer filter 3 including the T5 multilayer part has a main reflection band formed around 1000 nm (=λ_{M}=λ₀) as well as a new reflection band formed in a wavelength range at a wavelength which is five times the main reflection wavelength λ_{M}, a new reflection band formed in a wavelength range at a wavelength which is 5/3 the main reflection wavelength λ_{M}, and a new reflection band formed in a wavelength range at a wavelength which is 5/7 the main reflection wavelength λ_{M}.

As illustrated in FIG. 5, the multilayer filter 4 including the T6 multilayer part has a main reflection band formed around 1000 nm (=λ_{M}=λ₀) as well as a new reflection band formed in a wavelength range at a wavelength which is three times the main reflection wavelength λ_{M}, a new reflection band formed in a wavelength range at a wavelength which is 3/2 the main reflection wavelength λ_{M}, and a new reflection band formed in a wavelength range at a wavelength which is ¾ the main reflection wavelength λ_{M}.

As described above, in the multilayer filters including the T3-T6 multilayer parts, new reflection bands are formed which cannot be formed in multilayer filters according to the prior art. Here, the multilayer filters including the multilayer parts having the T3-T6 film-thickness structures were illustrated; however, film-thickness structures are not limited to these. Multilayer filters including a multilayer part having a T7 or higher film-thickness structure can also be configured, and new reflection bands are also formed in these filters. In addition, in the illustrations above, although explanations were given regarding new reflection bands formed at 500 nm or greater when main reflection bands are formed around 1000 nm, a new reflection band formed in a wavelength range at a shorter wavelength may also be used.

In regard to the aforementioned multilayer filters, if the wavelength of a new reflection band formed in the wavelength range at the longest wavelength is defined as a standard, the other new reflection bands and the main reflection bands are formed in wavelength ranges each of which is a new reflection band formed in the wavelength range at the longest wavelength divided by an integer.

New reflection bands formed in the aforementioned multilayer filter have the following properties.

First, the new reflection bands have a property such that, as the difference in film thickness between layers included in the basic configuration becomes larger, the reflectivity and the reflection bandwidth increase. In other words, as the difference in film thickness between the layers becomes smaller, the reflectivity and the reflection bandwidth decrease. Accordingly, by changing the film thickness of the basic configuration, the reflectivity and the reflection bandwidth of the new reflection band can be adjusted.

Second, the new reflection bands have a property such that as the number of stacked basic configurations becomes larger, the reflectivity becomes higher. Basically, the number of stacked basic configurations does not affect the reflection bandwidth. Therefore, by increasing the number of stacked basic configurations, the reflectivity of the new reflection band can be improved.

Third, the new reflection bands have a property such that the ripple generation pattern (the waviness of a spectral transmittance characteristic in a transmission band) changes depending on the film thickness setting of all layers included in the basic configuration. Accordingly, in accordance with the used wavelength range, the ripple generation pattern can be adjusted.

Fourth, some new reflection bands have a property such that even if the incident light is oblique, the spectral transmittance characteristic with respect to P polarized light and the spectral transmittance characteristic with respect to S polarized light may be identical with each other within the wavelength range at one end of the new reflection band. As a result of this, even when a multilayer filter is placed at a slant, by adequately using a new reflection band having this property, a steep spectral transmittance characteristic with respect to incident light (containing P polarized light and S polarized light) is provided within a wavelength range at one end of the new reflection band. An optical filter separating oblique incident light in two directions by allowing passage of it or reflecting it on the basis of the wavelength or combining oblique incident light within different wavelength ranges extending in two directions into light extending in one direction is called a dichroic mirror. The fourth property indicated here is useful for a dichroic mirror.

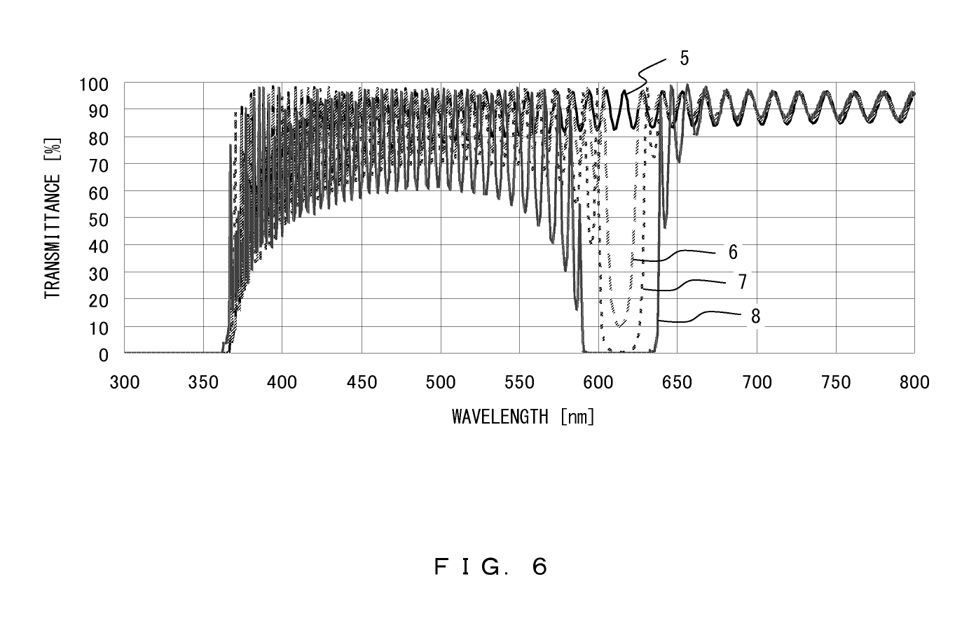

In the following, the first to third properties of a new reflection band will be specifically described with reference to FIGS. 6, 7 and 8. The fourth property will be specifically described in the embodiments described later.

FIG. 6 is a diagram illustrating relationships between a film-thickness difference and a reflectivity and between a film-thickness difference and a reflection bandwidth in a multilayer filter including the T4 multilayer part. FIG. 6 illustrates the spectral transmittance characteristics of a plurality of multilayer filters having different film thicknesses (a multilayer filter 5, a multilayer filter 6, a multilayer filter 7, and a multilayer filter 8). The following are film configurations of the plurality of multilayer filters whose spectral transmittance characteristics are illustrated in FIG. 6.

Multilayer filter 5

Substrate/(0.5H 0.5L 0.5H 0.5L)50/Air

Multilayer filter 6

Substrate/(0.5H 0.5L 0.55H 0.45L)50/Air

Multilayer filter 7

Substrate/(0.5H 0.5L 0.6H 0.4L)50/Air

Multilayer filter 8

Substrate/(0.5H 0.5L 0.7H 0.3L)50/Air

The design standard wavelength λ₀ and the refractive indexes n_{H}, n_{L}, n_{S}, and n_{A} of the H layer, the L layer, the substrate, and air in all of the multilayer filters 5, 6, 7 and 8 are as follows.

λ₀=600 nm, n_{H}=2.2, n_{L}=1.46, n_{S}=1.52, n_{A}=1.0

In all the basic configurations, the average film thickness of the layers is 0.5, and hence the main reflection wavelength λ_{M} is 300 nm.

The multilayer filter 5 does not have the T4 film-thickness structure, but is a multilayer filter according to a prior art which has a basic configuration composed of two layers. Therefore, as illustrated in FIG. 6, in the multilayer filter 5, a reflection band is not formed on a longer-wavelength side than the main reflection band formed at 300 nm. Meanwhile, in all of the multilayer filters 6, 7 and 8 including a multilayer part having the T4 film-thickness structure, a new reflection band is formed in the wavelength range at a wavelength (=600 nm) which is twice the main reflection wavelength λ_{M}.

The reflectivities and the reflection bandwidths of new reflection bands of the multilayer filters 6, 7 and 8 increase in numerical order. This order is the same as the order in which the difference in film thickness between layers increases. Accordingly, a new reflection band has a property such that as the difference in film thickness between layers included in the basic configuration becomes larger, the reflectivity and the reflection band width become greater.

As the difference in film thickness becomes larger, ripples around the new reflection band (the waviness of a spectral transmittance characteristic in the transmission band) are generated more remarkably. However, ripples can be suppressed by providing antireflection layers (AR layers) or matching layers (ML layers) before and after the multilayer part. In addition, as will be described later in the embodiments, ripples can also be suppressed by adjusting the film thicknesses of all layers included in the multilayer part.

Here, multilayer filters including the T4 multilayer part were described as examples; however, the configuration is not particularly limited to this. A new reflection band formed by a multilayer filter including the T3 multilayer part or the T5 or higher multilayer part has similar properties.

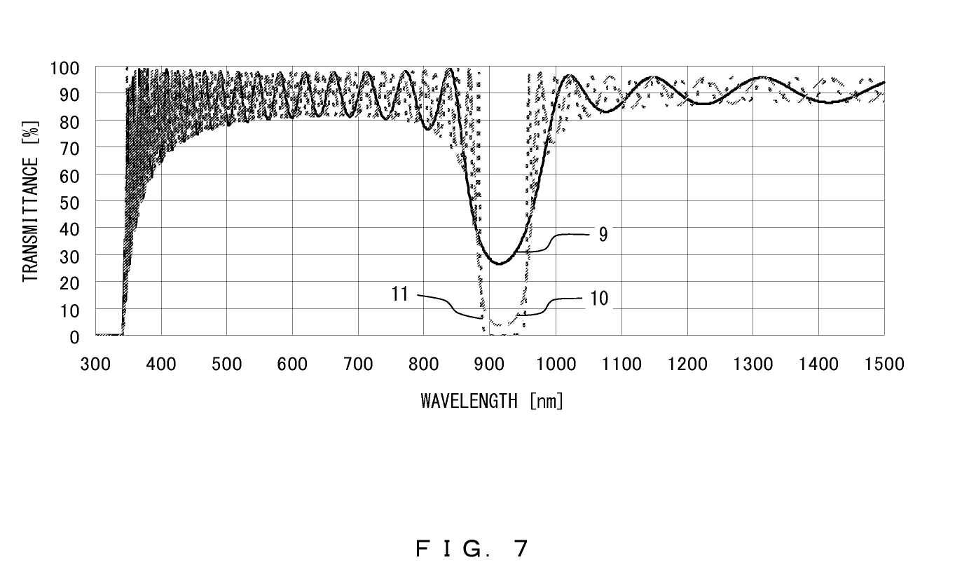

FIG. 7 is a diagram illustrating a relationship between the number of stacked basic configurations and a reflectivity in a multilayer filter including the T3 multilayer part. FIG. 7 illustrates the spectral transmittance characteristics of a plurality of multilayer filters in which each has a different number of stacked basic configurations (a multilayer filter 9, a multilayer filter 10, and a multilayer filter 11). The following are film configurations of the plurality of multilayer filters whose spectral transmittance characteristics are illustrated in FIG. 7.

Multilayer filter 9

Substrate/(0.8H 1.3L 0.9H 0.8L 1.3H 0.9L)10/Air

Multilayer filter 10

Substrate/(0.8H 1.3L 0.9H 0.8L 1.3H 0.9L)20/Air

Multilayer filter 11

Substrate/(0.8H 1.3L 0.9H 0.8L 1.3H 0.9L)40/Air

The design standard wavelength λ₀ and the refractive indexes n_{H}, n_{L}, n_{S}, and n_{A} of the H layer, the L layer, the substrate, and air in all of the multilayer filters 9, 10 and 11 are as follows.

λ₀=300 nm, n_{H}=2.2, n_{L}=1.46, n_{S}=1.52, n_{A}=1.0

In all the basic configurations, the average film thickness of the layers is 1, which is ¼ of the design standard wavelength λ₀, and hence the main reflection wavelength λ_{M} is also 300 nm.

As illustrated in FIG. 7, in all of the multilayer filters 9, 10 and 11 including the T3 multilayer part, a new reflection band is formed in a wavelength range at a wavelength (=900 nm) which is three times the main reflection wavelength λ_{M}.

The reflectivities of the new reflection bands of the multilayer filters 9, 10 and 11 increase in numerical order. This order is the same as the order in which the number of stacked basic configurations increases. Therefore, a new reflection band has a property such that as the number of stacked basic configurations increases, the reflectivity becomes greater.

Although ripples are generated around the new reflection band, they can be suppressed by providing antireflection layers (AR layers) or matching layers (ML layers) before and after the multilayer part. In addition, as will be described later in the embodiments, ripples can also be suppressed by adjusting the film thicknesses of all layers included in the multilayer part.

Here, multilayer filters including the T3 multilayer part were described as examples; however, the configuration is not particularly limited to these. A new reflection band formed by a multilayer filter including the T4 or higher multilayer part has similar properties.

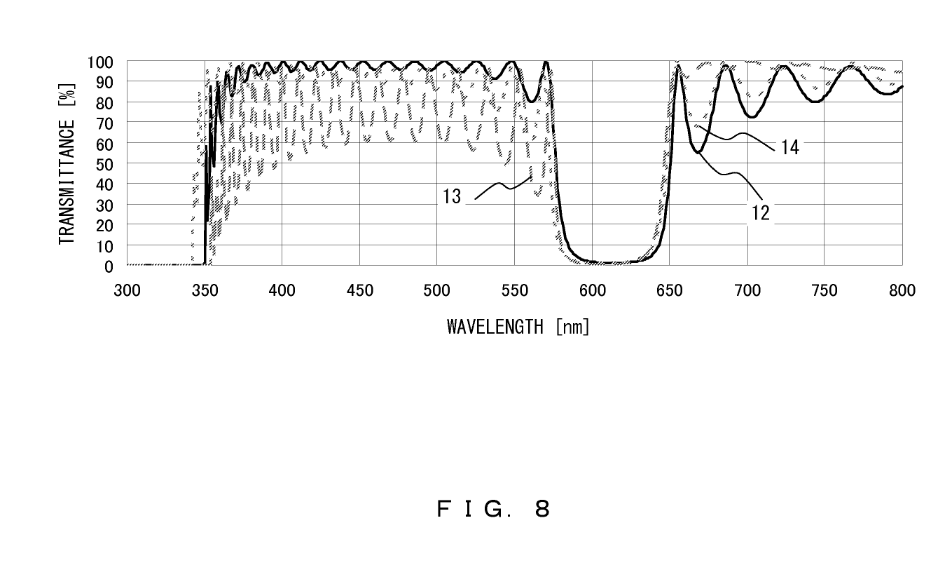

FIG. 8 is a diagram illustrating a relationship between a ripple-generation pattern and film thickness settings of all layers included in a basic configuration in a multilayer filter including the T4 multilayer part. FIG. 8 illustrates the spectral transmittance characteristics of a plurality of multilayer filters in which film thickness settings of all layers included in the basic configuration are different (a multilayer filter 12, a multilayer filter 13, and a multilayer filter 14). The following are film configurations of the plurality of multilayer filters whose spectral transmittance characteristics are illustrated in FIG. 8.

Multilayer filter 12

Substrate/(0.25H 0.45L 0.41H 0.9L)20/Air

Multilayer filter 13

Substrate/(0.4H 0.85L 0.35H 0.4L)20/Air

Multilayer filter 14

Substrate/(0.35H 0.5L 0.15H 1L)20/Air

The design standard wavelength λ₀ and the refractive indexes n_{H}, n_{L}, n_{S}, and n_{A} of the H layer, the L layer, the substrate, and air in all of the multilayer filters 12, 13 and 14 are as follows.

λ₀=600 nm, n_{H}=2.2, n_{L}=1.46, n_{S}=1.52, n_{A}=1.0

In all the basic configurations, the average film thickness of the layers is 0.5, and hence the main reflection wavelength λ_{M} is 300 nm.

As illustrated in FIG. 8, in all of the multilayer filters 12, 13 and 14 including the T4 multilayer part, a new reflection band is formed in a wavelength range at a wavelength (=600 nm) which is twice the main reflection wavelength λ_{M}.

In the multilayer filter 12, ripples on the short wavelength side of the new reflection band are small, and ripples generated on the long wavelength side are larger; by contrast, in the multilayer filter 13, ripples on the long wavelength side of the new reflection band are small, and ripples generated on the short wavelength side are larger. In the multilayer filter 14, ripples on the long wavelength side of the new reflection band and those on the short wavelength side are essentially equal.

As described above, the ripple generation pattern generated around the new reflection band is different for each of the multilayer filters 12, 13 and 14. Therefore, new reflection bands have a property such that the ripple generation pattern changes depending on the film thickness settings of all layers included in the basic configuration.

Here, multilayer filters including the T4 multilayer part were described as examples; however, the configuration is not particularly limited to these. A new reflection band formed by a multilayer filter including the T3 multilayer part or the T5 or higher multilayer part has similar properties.

Next, by comparing a multilayer filter including the T3 multilayer part and a multilayer filter including the T4 multilayer part, their characteristics will be described.

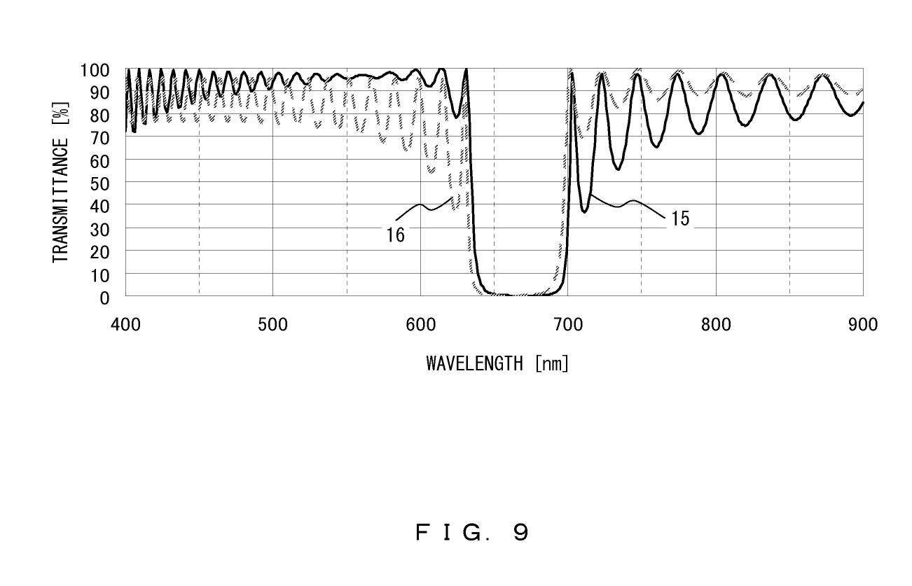

FIG. 9 is a diagram illustrating a spectral transmittance characteristic of a multilayer filter including the T3 multilayer part and a spectral transmittance characteristic of a multilayer filter including the T4 multilayer part.

A multilayer filter 15 including the T4 multilayer part and a multilayer filter 16 including the T3 multilayer part illustrated in FIG. 9 have new reflection bands having equivalent reflection band widths and equivalent reflectivities in equivalent wavelength ranges. The following are film configurations of the multilayer filters 15 and 16.

Multilayer filter 15

Substrate/(0.5H 0.35L 0.5H 0.65L)30/Air

Multilayer filter 16

Substrate/(0.46H 0.27L 0.27H 0.46L 0.27H 0.27L)30/Air

The design standard wavelength λ₀ and the refractive indexes n_{H}, n_{L}, n_{S}, and n_{A} of the H layer, the L layer, the substrate, and air in all of the multilayer filters 15 and 16 areas follows.

λ₀=650 nm, n_{H}=2.2, n_{L}=1.46, n_{S}=1.52, n_{A}=1.0

The average film thickness of the layers in the basic configuration in the multilayer filter 15 is 0.5, and hence the main reflection wavelength λ_{M} will be 325 nm on the basis of calculation. Meanwhile, the average film thickness of the layers in the basic configuration in the multilayer filter 16 is 0.33, and hence the main reflection wavelength λ_{M} will be approximately 217 nm on the basis of calculation.

The reason why the main reflection wavelength λ_{M} is indicated here as a calculation-based value is that, since the refractive indexes of actual thin films indicate dispersion (dependence on wavelength), reflection bands are not formed exactly around the wavelength. This is also true for the other explanations herein and/or in the claims. In other words, the expressions “a reflection band is provided proximate to a wavelength ⅕ the standard wavelength” and “a reflection band is provided proximate to a wavelength ⅓ the standard wavelength” herein and/or in the claims indicate that a reflection band is not formed exactly around the wavelength due to refractive-index dispersion but is formed proximate to the wavelength.

As illustrated in FIG. 9, the distance between the main reflection band of the multilayer filter 16 and the new reflection band of the multilayer filter 16 formed at a wavelength longer than the wavelength of the main reflection band is longer than the distance between the main reflection of the multilayer filter 15 and the new reflection band of the multilayer filter 15 formed at a wavelength longer than the wavelength of the main reflection band. More specifically, when it is assumed that the aforementioned design standard wavelength λ₀ is a standard, the distance between the main reflection band of the multilayer filter 16 and the new reflection band of the multilayer filter 16 formed at a wavelength longer than the wavelength of the main reflection band will be on the order of ⅔ the design standard wavelength λ₀ (=λ₀−λ₀/3) and the distance between the main reflection band of the multilayer filter 15 and the new reflection band of the multilayer filter 15 formed at a wavelength longer than the wavelength of the main reflection band will be on the order of ½ the design standard wavelength λ₀ (=λ₀−λ₀/2).

Accordingly, when great importance is attached to securing a wider transmission wavelength range, the T3 multilayer filter 16 is more preferable than the multilayer filter 15 including the T4 multilayer part.

Meanwhile, in order to form new reflection bands having equivalent reflection band widths and equivalent reflectivities, the total film thickness of the multilayer filter 15 and that of the multilayer filter 16 will not be made to be much different but the multilayer filter 16 will be made to have a larger number of layers than the multilayer filter 15. Specifically, the multilayer filter 15 includes 120 layers and the multilayer filter 16 includes 180 layers. Accordingly, since the multilayer filter 15 including fewer layers can have layers in which each has a greater film thickness, the manufacturability of the multilayer filter 15 is superior.

Therefore, when great importance is attached to manufacturability of a multilayer filter, the multilayer filter 15 including the T4 multilayer part is more preferable than the multilayer filter 16 including the T3 multilayer part.

In comparison with multilayer filters according to the prior art, a multilayer filter including the T5 or higher multilayer part is also useful as with the multilayer filters 15 and 16. In particular, the utility of a multilayer filter including the T5 multilayer part is high partly because it can form, as already indicated, a reflection band at a wavelength longer than the wavelengths at which multilayer filters including the T3 and T4 multilayer parts form reflection bands (i.e., the wavelength range at a wavelength five times the main reflection wavelength).

A multilayer filter including the T6 multilayer part can be used as a variation of a multilayer filter including the T3 multilayer part, and its utility is high as with the multilayer filter including the T3 multilayer part. The utility of the multilayer filter including the T6 multilayer part will be illustrated as follows. When oblique light is incident on the multilayer filter including the T3 multilayer part, a reflection (ripple) is unintentionally caused due to a change in the effective refractive index of the high refractive index layer (H layer) and the effective refractive index of the low refractive index layer (L layer). The reflection can be suppressed by adjusting the film thickness of the high refractive index layer and that of the low refractive index layer at a certain ratio, and, as a result of the adjustment, the multilayer filter will include the T6 multilayer part. In other words, as an example, when oblique light is incident, the multilayer filter including the T6 multilayer part functions as a variation of a multilayer filter including the T3 multilayer part, and its usability is high as with the multilayer filter including the T3 multilayer part.

However, a multilayer filter including the T5 or higher multilayer part tends to have a larger number of layers than the multilayer filters 15 and 16, and its total film thickness also tends to increase. In other words, in regard to a multilayer filter including a multilayer part having a cyclic film-thickness structure in which three or more layers are defined as one cycle, as the number of layers included in the cyclic film-thickness structure of the multilayer part increases, the number of layers increases, and, as a result of this, manufacturability will be degraded.

Judging from the points indicated above, a multilayer filter defining six or fewer layers as one cycle, which shows a high utility, depending on application, is preferable, and a multilayer filter including the T3 or T4 multilayer part, which shows an especially high utility, is especially preferable.

In addition, by comparing a multilayer filter including the T3 multilayer part with multilayer filters according to the prior art, characteristics of multilayer filters according to embodiments represented by the multilayer filter including the T3 multilayer part will be described.

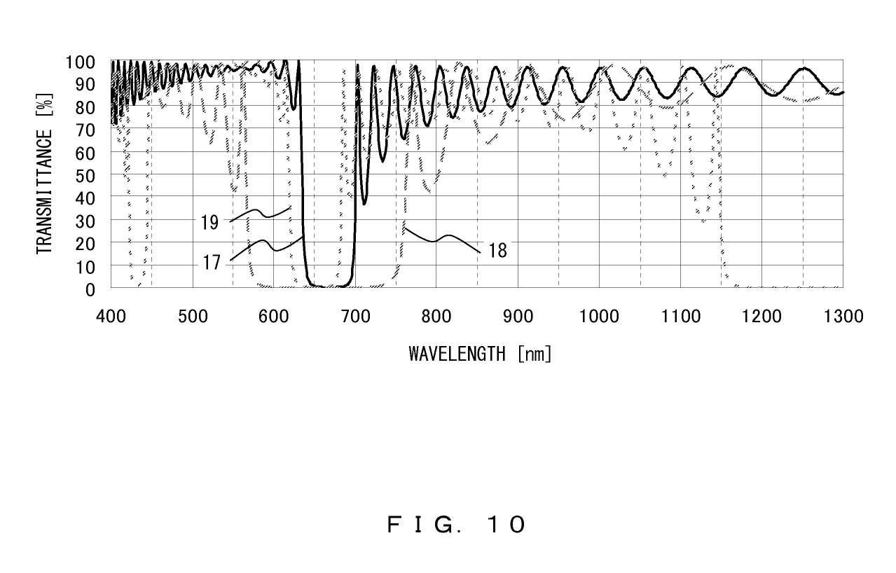

FIG. 10 is a diagram illustrating a spectral transmittance characteristic of a multilayer filter including the T3 multilayer part, and spectral transmittance characteristics of two multilayer filters according to a prior art.

As illustrate in FIG. 10, a multilayer filter 17 including the T3 multilayer part has a new reflection band in the vicinity of 650 nm which is formed at a wavelength longer than the wavelength of the main reflection band. Two multilayer filters 18 and 19 according to a prior art respectively have a main reflection band and a second order reflection band in the vicinity of 650 nm.

The multilayer filter 18 is what is called a QWOT stack, and the multilayer filter 19 is a multilayer filter for which the aforementioned technology disclosed in Japanese Laid-open Patent Publication No. 2006-023471 is used. Both the multilayer filters 18 and 19 are multilayer filters in which basic configurations each composed of two layers are stacked.

The following are film configurations of the multilayer filters 17, 18 and 19.

Multilayer filter 17

Substrate/(0.5H 0.35L 0.5H 0.65L)30/Air

Multilayer filter 18

Substrate/(1H 1L)12/Air

Multilayer filter 19

Substrate/(1.55H 2.45L)15/Air

The design standard wavelength λ₀ and the refractive indexes n_{H}, n_{L}, n_{S}, and n_{A} of the H layer, the L layer, the substrate, and air in all of the multilayer filters 17, 18 and 19 are as follows.

λ₀=650 nm, n_{H}=2.2, n_{S}=1.52, n_{A}=1.0

The average film thickness of the layers in the basic configuration in the multilayer filter 17 is 0.5, and hence the main reflection wavelength λ_{M} is 325 nm. The average film thickness of the layers in the basic configuration in the multilayer filter 18 is 1, and hence the main reflection wavelength λ_{M} is 650 nm. The average film thickness of the layers in the basic configuration in the multilayer filter 19 is 2, and hence the main reflection wavelength λ_{M} is 1300 nm.

As illustrated in FIG. 10, when the multilayer filter 18 is composed of the same material as that of the other multilayer filters, the reflection bandwidth of the main reflection band of the multilayer filter 18 is wider than the reflection bandwidths of the reflection bands of the other multilayer filters. The multilayer filter 19 has a narrow second order reflection band; however, it does not have a wide transmission band since intervals are narrow between the second order reflection band (650 nm) and the main reflection band (1300 nm) formed in the wavelength range after the second order reflection band and between the second order reflection band (650 nm) and a third order reflection band (433 nm) formed in the wavelength range before the second order reflection band. As described above, the multilayer filters 18 and 19 cannot have both a narrow reflection band and a wide transmission band. By contrast, the multilayer filter 17 has a narrow reflection band (a new reflection band) and a wide transmission band.

As described above, a multilayer filter having a cyclic film-thickness structure in which three or more layers are defined as one cycle can achieve characteristics different from those of multilayer filters according to the prior art. Therefore, using the aforementioned structures, it is possible to provide a minus filter of high manufacturability which has a narrow reflection band and a wide transmission band and which can be manufactured through a conventional manufacturing technology, and to provide a dichroic mirror having a spectral transmittance characteristic with respect to P polarized light and a spectral transmittance characteristic with respect to S polarized light which are identical with each other in the used wavelength range.

In the descriptions above, the properties were explained under exemplary situations in which the refractive indexes of the H layer, the L layer, the substrate, and air are as follows.

n_{H}=2.2, n_{H}=1.46, n_{S}=1.52, n_{A}=1.0

However, the properties are not limited to use in the situations above. They can also be used when other refractive indexes or other materials are used.

Embodiments will be described in the following. In embodiments 1 to 6, specific examples of a multilayer filter including the T3 multilayer part having the T3 film-thickness structure will be disclosed. In embodiments 7 to 11, specific examples of a multilayer filter including the T4 multilayer part having the T4 film-thickness structure will be disclosed.

### Embodiment 1

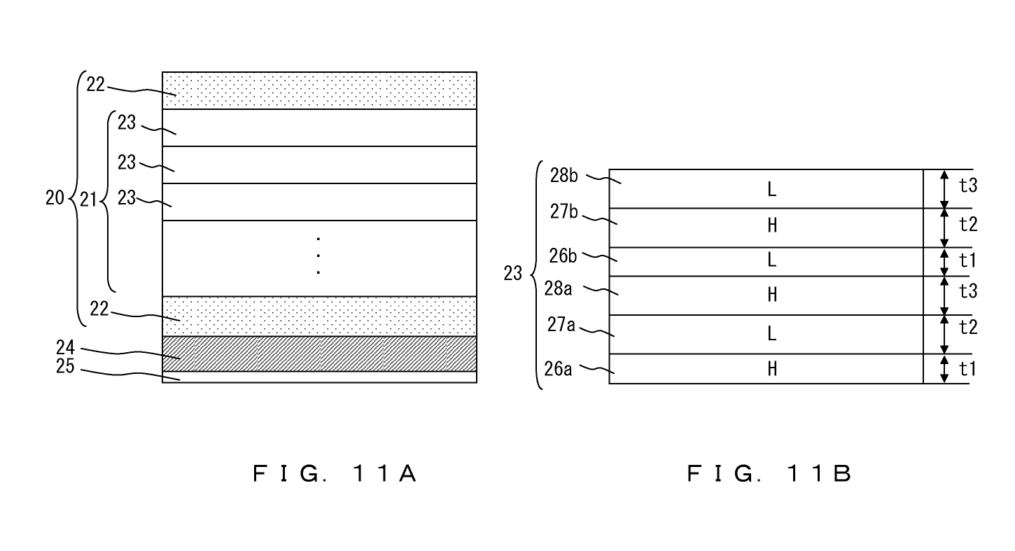

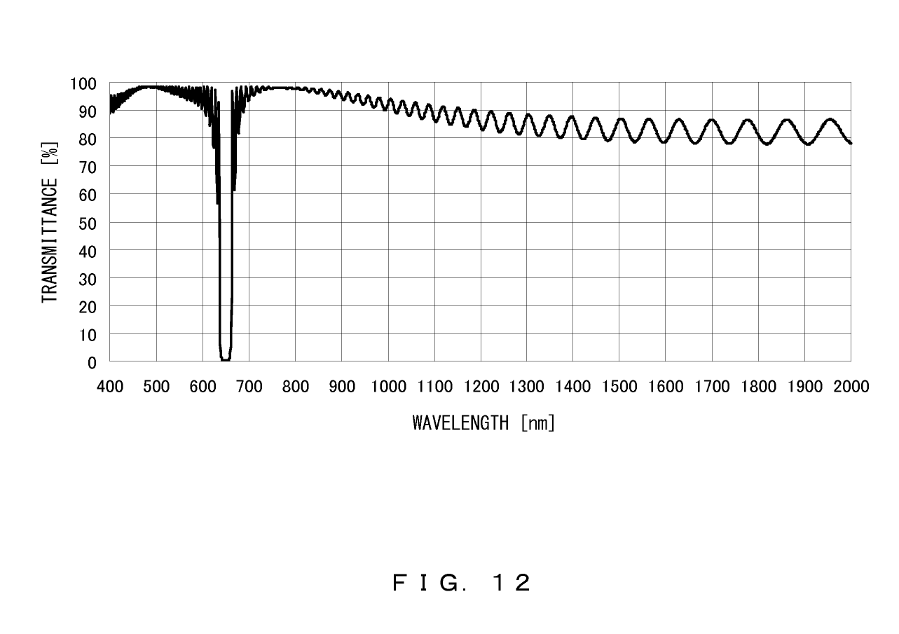

FIG. 11A is a schematic view showing a configuration of a multilayer filter according to the present embodiment. FIG. 11B is a schematic view showing a basic configuration for configuring a multilayer part included in the multilayer filter shown in FIG. 11A. FIG. 12 is a diagram showing a spectral transmittance characteristic of the multilayer filter according to the present embodiment.

As illustrated in FIG. 11A, a multilayer filter 20 according to the present embodiment includes: a multilayer part 21 in which layers composed of a high refractive index material (a first material) (hereinafter referred to as H layers) and layers composed of a low refractive index material (a second material) (hereinafter referred to as L layers) are stacked in an alternating pattern; and matching parts 22. The multilayer filter 20 is formed on the main film-formation surface of a transparent substrate 24 which is a both-side-polished parallel plate, and an antireflection film 25 is formed on the back side of the substrate 24.

The high refractive index material and the low refractive index material are Ta2O5 and SiO2, respectively. The H layer and the L layer are formed using an ion assisted deposition (IAD). The material of the substrate 24 is BK7, and the antireflection film 25 is a monolayer composed of MgF2.

The film configuration of the multilayer filter 20 and the design standard wavelength λ₀ are as follows.

Substrate/0.18H 0.13L (0.28L 0.36H 0.36L 0.28H 0.36L 0.36H)60 1.4H 0.13L 0.34H 0.83L/Air

Design standard wavelength λ₀=636 nm (Main reflection wavelength λ_{M}=λ₀/3)

As indicated by the film configuration above, the multilayer part 21 is a structure in which basic configurations 23 are stacked, and has a cyclic film-thickness structure in which three layers are defined as one cycle.

As shown in FIG. 11B, the basic configuration 23 is composed of a first layer 26a having a first optical film thickness t1; a second layer 27a stacked on the first layer 26a and having a second optical film thickness t2; a third layer 28a stacked on the second layer 27a and having a third optical film thickness t3; a fourth layer 26b stacked on the third layer 28a and having the first optical film thickness t1; a fifth layer 27b stacked on the fourth layer 26b and having the second optical film thickness t2; and a sixth layer 28b stacked on the fifth layer 27b and having the third optical film thickness t3.

The film thickness tb of the basic configuration and the total optical film thickness tc of the three optical film thicknesses, the first optical film thickness t1, the second optical film thickness t2, and the third optical film thickness t3, are as follows.

t1=0.28λ₀/4, t2=0.36λ₀/4, t3=0.36λ₀/4

tc=λ₀/4, tb=λ₀/2

The first optical film thickness t1, the second optical film thickness t2, and the third optical film thickness t3 establish the following relationship.

t1/t2=0.78

t2=t3

As indicated by the film configuration above, the matching part 22 includes one or more matching layers for suppressing ripples generated around the reflection band of the multilayer filter 20. The matching layer is also composed of a material similar to that of the H layer and the L layer.

As shown in FIG. 12, in the multilayer filter 20, a reflection band having a 28 nm reflection width is formed around 650 nm, which is a wavelength approximately 1.02 times the design standard wavelength λ₀. Accordingly, the multilayer filter 20 is preferable as a minus filter having a narrow reflection band and a wide transmission band.

The reflection band formed around 650 nm is a new reflection band which is not formed in multilayer filters according to the prior art. In other words, because of the structure above that is different from those of multilayer filters according to the prior art, the multilayer filter 20 achieves a desired characteristic as a minus filter.

### Embodiment 2

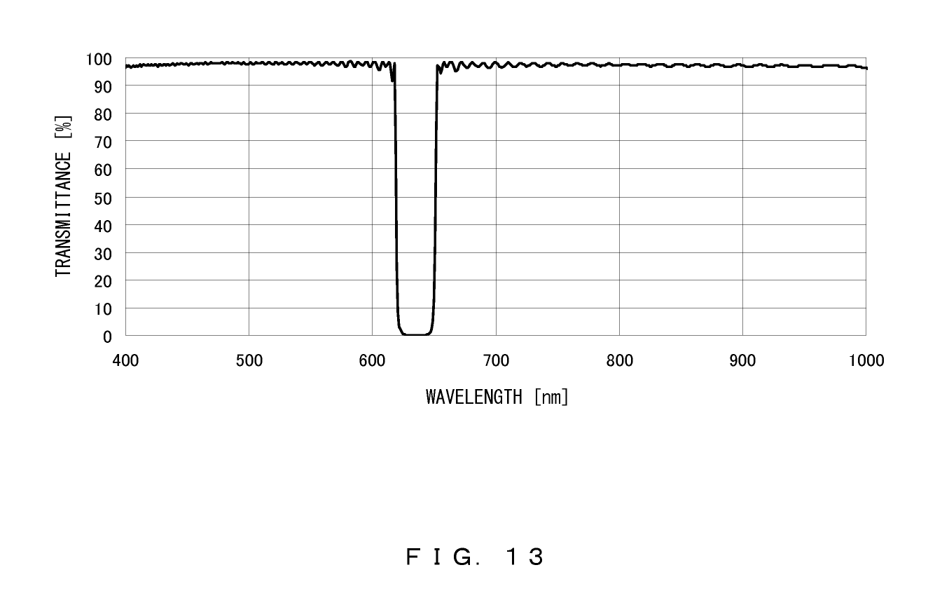

FIG. 13 is a diagram showing a spectral transmittance characteristic of a multilayer filter according to the present embodiment.

A multilayer filter 30 according to the present embodiment has a configuration similar to that of the multilayer filter 20 according to embodiment 1 except for the fact that the multilayer filter 30 has more matching layers included in the matching part in order to further suppress ripples generated around the reflection band. The materials of the components are also similar to the materials of the components of the multilayer filter 20 according to embodiment 1.

The film configuration of the multilayer filter 30 and the design standard wavelength λ₀ are as follows.

Substrate/0.146H 0.307L 0.236H 0.276L 0.35H 0.286L 0.344H 0.216L 0.38H 0.289L 0.326H 0.397L 0.256H 0.374L 0.334H 0.316L 0.358H 0.289L 0.361H 0.244L 0.417H 0.254L 0.33H 0.388L 0.266H 0.454L 0.306H 0.347L 0.204H 0.3L 0.256H 0.372L 0.365H 0.289L 0.352H 0.355L 0.306H 0.356L 0.347H 0.296L 0.346H 0.358L 0.291H 0.347L 0.353H 0.295L 0.349H 0.357L 0.287H 0.354L 0.355H 0.29L 0.348H 0.359L 0.287H 0.357L 0.353H 0.287L 0.353H 0.359L 0.284H 0.355L 0.355H 0.287L 0.353H 0.36L 0.28H 0.359L 0.357H 0.283L 0.355H 0.361L 0.281H 0.361L 0.357H 0.282L 0.357H 0.363L 0.278H 0.36L 0.358H 0.281L 0.357H 0.363L 0.276H 0.363L 0.36H 0.278L 0.358H 0.364L 0.275H 0.364L 0.359H 0.278L 0.359H 0.365L 0.274H 0.363L 0.361H 0.276L 0.36H 0.366L 0.271H 0.366L 0.361H 0.275L 0.361H 0.365L 0.271H 0.366L 0.361H 0.273L 0.361H 0.367L 0.269H 0.366L 0.362H 0.273L 0.363H 0.367L (0.263H 0.37L 0.366H 0.266L 0.365H 0.37L) 28 0.265H 0.368L 0.364H 0.268L 0.363H 0.371L 0.264H 0.369L 0.366H 0.268L 0.366H 0.367L 0.265H 0.37L 0.362H 0.27L 0.362H 0.368L 0.268H 0.366L 0.364H 0.269L 0.364H 0.37L 0.265H 0.369L 0.363H 0.271L 0.364H 0.364L 0.269H 0.367L 0.361H 0.273L 0.36H 0.368L 0.27H 0.366L 0.363H 0.272L 0.364H 0.367L 0.268H 0.368L 0.36H 0.276L 0.362H 0.361L 0.273H 0.364L 0.361H 0.276L 0.357H 0.369L 0.273H 0.366L 0.361H 0.274L 0.364H 0.363L 0.273H 0.365L 0.355H 0.282L 0.357H 0.359L 0.278H 0.361L 0.361H 0.278L 0.357H 0.366L 0.276H 0.366L 0.354H 0.279L 0.363H 0.356L 0.279H 0.36L 0.351H 0.29L 0.351H 0.358L 0.283H 0.359L 0.363H 0.279L 0.358H 0.364L 0.28H 0.368L 0.339H 0.288L 0.36H 0.343L 0.291H 0.346L 0.354H 0.303L 0.341H 0.369L 0.28H 0.369L 0.377H 0.247L 0.386H 0.266L 0.363H 0.3L 0.432H 0.261L 0.379H 0.319L 0.277H 0.378L 0.345H 0.378L 0.315H 0.377L 0.257H 0.354L 0.407H 0.251L 0.38H 0.26L 0.341H 0.352L 0.277H 0.343L 0.263H 0.498L 0.356H 0.274L 1.674H 0.148L 0.374H 0.923L/Air

Design standard wavelength λ₀=622 nm (Main reflection wavelength λ_{M}=On the order of λ₀/3)

As indicated by the film configuration above, the multilayer part is a structure in which basic configurations are stacked. In the basic configuration, the optical film thickness of a first layer is almost equivalent to that of a fourth layer, the optical film thickness of a second layer is almost equivalent to that of a fifth layer, and the optical film thickness of a third layer is almost equivalent to that of a sixth layer. The multilayer part essentially has a cyclic film-thickness structure in which three layers are defined as one layer.

In other words, the basic configuration is composed of: a first layer having an optical film thickness within a first range r1; a second layer stacked on the first layer and having an optical film thickness within a second range r2; a third layer stacked on the second layer and having an optical film thickness within a third range r3; a fourth layer stacked on the third layer and having an optical film thickness within the first range r1; a fifth layer stacked on the fourth layer and having an optical film thickness within the second range r2; and a sixth layer stacked on the fifth layer and having an optical film thickness within the third range r3.

A first optical film thickness t1, which is the central value of the optical film thickness within the first range r1, a second optical film thickness t2, which is the central value of the optical film thickness within the second range r2, and a third optical film thickness t3, which is the central value of the optical film thickness within the third range r3 are different from each other; however, the second optical film thickness t2 and the third optical film thickness t3 are almost equal. The total optical film thickness tc of the three layers is about λ₀/4 and the film thickness tb of the basic configuration is about λ₀/2.

The first range r1 is from 0.263λ₀/4 to 0.266λ₀/4, and this range is extremely narrow in comparison with the film thickness. The second range r2 and the third range r3 are from 0.365λ₀/4 to 0.37λ₀/4, and these ranges are extremely narrow in comparison with the film thickness. The ratio of the first range r1 to the second range r2 is about 0.72.

As shown in FIG. 13, in the multilayer filter 30, a reflection band having a 32 nm reflection width is formed around 635 nm, which is a wavelength approximately 1.02 times the design standard wavelength λ₀. Accordingly, the multilayer filter 30 is preferable as a minus filter having a narrow reflection band and a wide transmission band.

In addition, in the multilayer filter 30, since ripples generated in the transmission band proximate to the reflection band are suppressed via fine film-thickness adjustment by the matching layer, the multilayer filter 30 has an improved transmission characteristic in comparison with the multilayer filter 20. Therefore, the multilayer filter 30 has a higher utility.

The reflection band formed around 635 nm is a new reflection band which is not formed in multilayer filters according to the prior art. In other words, because of the structure above that is different from those of multilayer filters according to the prior art, the multilayer filter 30 achieves a desired characteristic as a minus filter.

### Embodiment 3

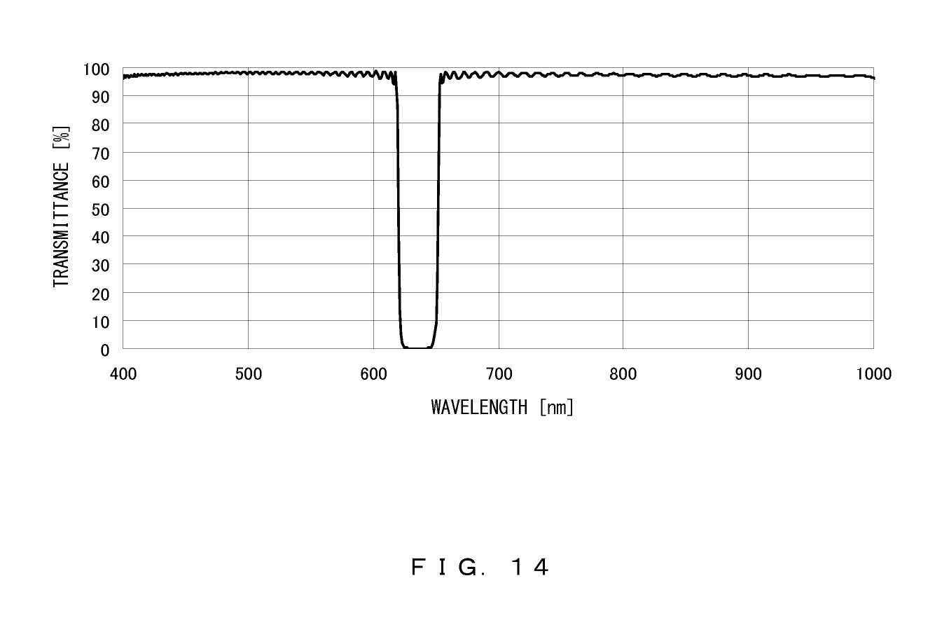

FIG. 14 is a diagram showing a spectral transmittance characteristic of a multilayer filter according to the present embodiment.

A multilayer filter 40 according to the present embodiment has a configuration similar to that of the multilayer filter 30 according to embodiment 2 except for the fact that the multilayer filter 40 does not have a strictly cyclic film-thickness structure but has a loosely cyclic film-thickness structure in order to further suppress ripples generated around the reflection band. The materials of the components are also similar to the materials of the components of the multilayer filter 30 according to embodiment 2.

The film configuration of the multilayer filter 40 and the design standard wavelength λ₀ are as follows.

Substrate/0.146H 0.307L 0.236H 0.276L 0.35H 0.286L 0.344H 0.216L 0.38H 0.289L 0.326H 0.397L 0.256H 0.374L 0.334H 0.316L 0.358H 0.289L 0.361H 0.244L 0.417H 0.254L 0.33H 0.388L 0.266H 0.454L 0.306H 0.347L 0.204H 0.3L 0.256H 0.372L 0.365H 0.289L 0.352H 0.355L 0.306H 0.356L 0.347H 0.296L 0.346H 0.358L 0.291H 0.347L 0.353H 0.295L 0.349H 0.357L 0.287H 0.354L 0.355H 0.29L 0.348H 0.359L 0.287H 0.357L 0.353H 0.287L 0.353H 0.359L 0.284H 0.355L 0.355H 0.287L 0.353H 0.36L 0.28H 0.359L 0.357H 0.283L 0.355H 0.361L 0.281H 0.361L 0.357H 0.282L 0.357H 0.363L 0.278H 0.36L 0.358H 0.281L 0.357H 0.363L 0.276H 0.363L 0.36H 0.278L 0.358H 0.364L 0.275H 0.364L 0.359H 0.278L 0.359H 0.365L 0.274H 0.363L 0.361H 0.276L 0.36H 0.366L 0.271H 0.366L 0.361H 0.275L 0.361H 0.365L 0.271H 0.366L 0.361H 0.273L 0.361H 0.367L 0.269H 0.366L 0.362H 0.273L 0.363H 0.367L 0.268H 0.368L 0.363H 0.271L 0.362H 0.367L 0.268H 0.367L 0.363H 0.27L 0.362H 0.369L 0.266H 0.368L 0.364H 0.269L 0.365H 0.368L 0.265H 0.369L 0.363H 0.269L 0.363H 0.369L 0.265H 0.368L 0.365H 0.267L 0.365H 0.37L 0.264H 0.369L 0.364H 0.268L 0.365H 0.369L 0.263H 0.369L 0.365H 0.267L 0.364H 0.369L 0.264H 0.37L 0.365H 0.266L 0.365H 0.37L 0.262H 0.37L 0.365H 0.266L 0.366H 0.369L 0.263H 0.37L 0.365H 0.266L 0.365H 0.37L 0.262H 0.371L 0.365H 0.265L 0.367H 0.37L 0.262H 0.371L 0.365H 0.266L 0.366H 0.37L 0.262H 0.37L 0.366H 0.266L 0.366H 0.37L 0.262H 0.371L 0.365H 0.265L 0.366H 0.37L 0.262H 0.37L 0.365H 0.266L 0.365H 0.37L 0.262H 0.37L 0.366H 0.266L 0.365H 0.37L 0.263H 0.371L 0.365H 0.266L 0.366H 0.37L 0.263H 0.369L 0.365H 0.267L 0.365H 0.371L 0.262H 0.37L 0.366H 0.266L 0.365H 0.37L 0.263H 0.37L 0.365H 0.266L 0.365H 0.37L 0.262H 0.369L 0.366H 0.266L 0.365H 0.371L 0.262H 0.37L 0.367H 0.265L 0.366H 0.37L 0.263H 0.37L 0.365H 0.266L 0.365H 0.371L 0.263H 0.369L 0.367H 0.266L 0.365H 0.371L 0.262H 0.371L 0.365H 0.266L 0.365H 0.369L 0.264H 0.369L 0.365H 0.266L 0.365H 0.371L 0.263H 0.369L 0.366H 0.267L 0.365H 0.369L 0.263H 0.37L 0.365H 0.267L 0.364H 0.368L 0.265H 0.368L 0.364H 0.268L 0.363H 0.371L 0.264H 0.369L 0.366H 0.268L 0.366H 0.367L 0.265H 0.37L 0.362H 0.27L 0.362H 0.368L 0.268H 0.366L 0.364H 0.269L 0.364H 0.37L 0.265H 0.369L 0.363H 0.271L 0.364H 0.364L 0.269H 0.367L 0.361H 0.273L 0.36H 0.368L 0.27H 0.366L 0.363H 0.272L 0.364H 0.367L 0.268H 0.368L 0.36H 0.276L 0.362H 0.361L 0.273H 0.364L 0.361H 0.276L 0.357H 0.369L 0.273H 0.366L 0.361H 0.274L 0.364H 0.363L 0.273H 0.365L 0.355H 0.282L 0.357H 0.359L 0.278H 0.361L 0.361H 0.278L 0.357H 0.366L 0.276H 0.366L 0.354H 0.279L 0.363H 0.356L 0.279H 0.36L 0.351H 0.29L 0.351H 0.358L 0.283H 0.359L 0.363H 0.279L 0.358H 0.364L 0.28H 0.368L 0.339H 0.288L 0.36H 0.343L 0.291H 0.346L 0.354H 0.303L 0.341H 0.369L 0.28H 0.369L 0.377H 0.247L 0.386H 0.266L 0.363H 0.3L 0.432H 0.261L 0.379H 0.319L 0.277H 0.378L 0.345H 0.378L 0.315H 0.377L 0.257H 0.354L 0.407H 0.251L 0.38H 0.26L 0.341H 0.352L 0.277H 0.343L 0.263H 0.498L 0.356H 0.274L 1.674H 0.148L 0.374H 0.923L/Air

Design standard wavelength λ₀=622 nm (Main reflection wavelength λ_{M}=On the order of λ₀/3)

As indicated by the film configuration above, since the multilayer filter 40 does not have a strictly cyclic film-thickness structure, a distinction is not clear between a multilayer part and a matching part. However, the multilayer filter 40 substantially has a cyclic film-thickness structure in which three layers are defined as one cycle.

In other words, also in the multilayer filter 40, a basic configuration can be found which is composed of: a first layer having an optical film thickness within a first range r1; a second layer stacked on the first layer and having an optical film thickness within a second range r2; a third layer stacked on the second layer and having an optical film thickness within a third range r3; a fourth layer stacked on the third layer and having an optical film thickness within the first range r1; a fifth layer stacked on the fourth layer and having an optical film thickness within the second range r2; and a sixth layer stacked on the fifth layer and having an optical film thickness within the third range r3.

A first optical film thickness t1, which is the central value of the optical thickness within the first range r1, a second optical film thickness t2, which is the central value of the optical film thickness within the second range r2, and a third optical film thickness t3, which is the central value of the optical film thickness within the third range r3, are different from each other; however, the second optical film thickness t2 and the third optical film thickness t3 are almost equal. The total optical film thickness tc of the three layers is about λ₀/4 and the film thickness tb of the basic configuration is about λ₀/2. The ratio of the first range r1 to the second range r2 is about 0.72.

As shown in FIG. 14, in the multilayer filter 40, a reflection band having a 32 nm reflection width is formed around 635 nm, which is a wavelength approximately 1.02 times the design standard wavelength λ₀. Accordingly, the multilayer filter 40 is preferable as a minus filter having a narrow reflection band and a wide transmission band.

In addition, in the multilayer filter 40, since ripples generated in the transmission band proximate to the reflection band are suppressed via fine film-thickness adjustment by the loosely cyclic film-thickness structure, the multilayer filter 40 has an improved transmission characteristic in comparison with the multilayer filter 20. Therefore, the multilayer filter 40 has a higher utility.

As indicated by the present embodiment, the cyclic film-thickness structure does not require a strict cyclic nature, but a certain level of cyclic nature is enough. Therefore, the cyclic film-thickness structure described herein is not limited to being those having a strict cyclic nature, but they include film-thickness structures having a certain level of cyclic nature.

The reflection band formed around 635 nm is a new reflection band which is not formed in multilayer filters according to the prior art. In other words, because of the structure above that is different from those of multilayer filters according to the prior art, the multilayer filter 40 achieves a desired characteristic as a minus filter.

### Embodiment 4

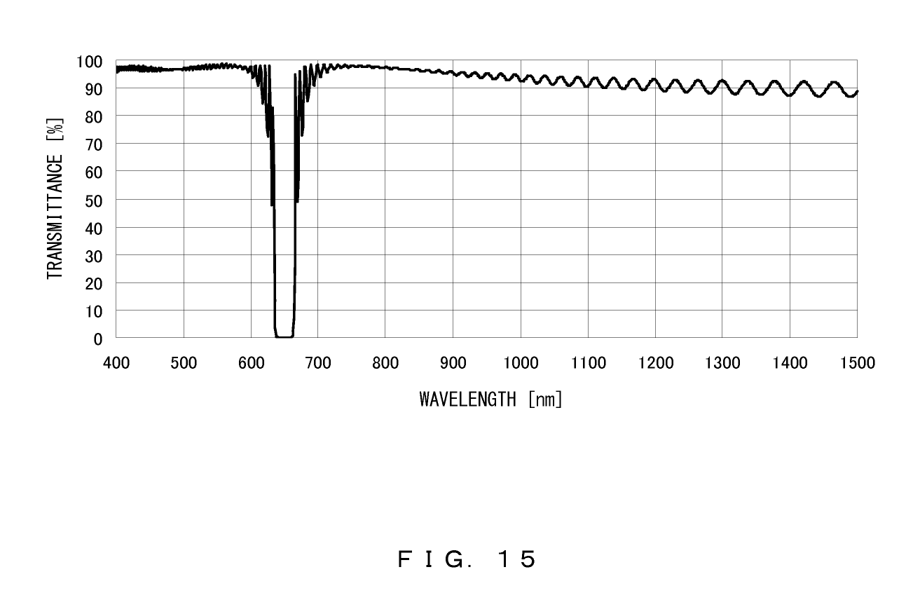

FIG. 15 is a diagram showing a spectral transmittance characteristic of a multilayer filter according to the present embodiment.

A multilayer filter 50 according to the present embodiment has a configuration similar to that of the multilayer filter 20 according to embodiment 1 except for the fact that in the multilayer filter 50, the first optical film thickness t1 is greater than the second optical film thickness t2 and the third optical film thickness t3. The materials of the components are also similar to the materials of the components of the multilayer filter 20 according to embodiment 1.

The film configuration of the multilayer filter 50 and the design standard wavelength λ₀ are as follows.

Substrate/0.191H 0.465L 0.293H (0.4L 0.3H 0.3L 0.4H 0.3L 0.3H)70 0.223H 0.32L 0.379H 0.993L/Air

Design standard wavelength λ₀=636 nm (Main reflection wavelength λ_{M}=λ₀/3)

As indicated by the film configuration above, the multilayer part is a structure in which basic configurations are stacked, and has a cyclic film-thickness structure in which three layers are defined as one cycle.

The film thickness tb of the basic configuration and the total optical film thickness tc of the three optical film thicknesses, the first optical film thickness t1, the second optical film thickness t2, and the third optical film thickness t3, are as follows.

t1=0.4λ₀/4, t2=0.3λ₀/4, t3=0.3λ₀/4

tc=λ₀/4, tb=λ₀/2

The first optical film thickness t1, the second optical film thickness t2, and the third optical film thickness t3 establish the following relationship.

t2/t1=0.75

t2=t3

As shown in FIG. 15, in the multilayer filter 50, a reflection band having a 31 nm reflection width is formed around 650 nm, which is a wavelength approximately 1.02 times the design standard wavelength λ₀. Accordingly, the multilayer filter 50 is preferable as a minus filter having a narrow reflection band and a wide transmission band.

In the multilayer filter 50 according to the present embodiment, by performing film thickness adjustment similar to the film thickness adjustment performed for the multilayer filter according to embodiment 2 or 3, ripples can also be suppressed to improve the transmission characteristic.

The reflection band formed around 650 nm is a new reflection band which is not formed in multilayer filters according to the prior art. In other words, because of the structure above that is different from those of multilayer filters according to the prior art, the multilayer filter 50 achieves a desired characteristic as a minus filter.

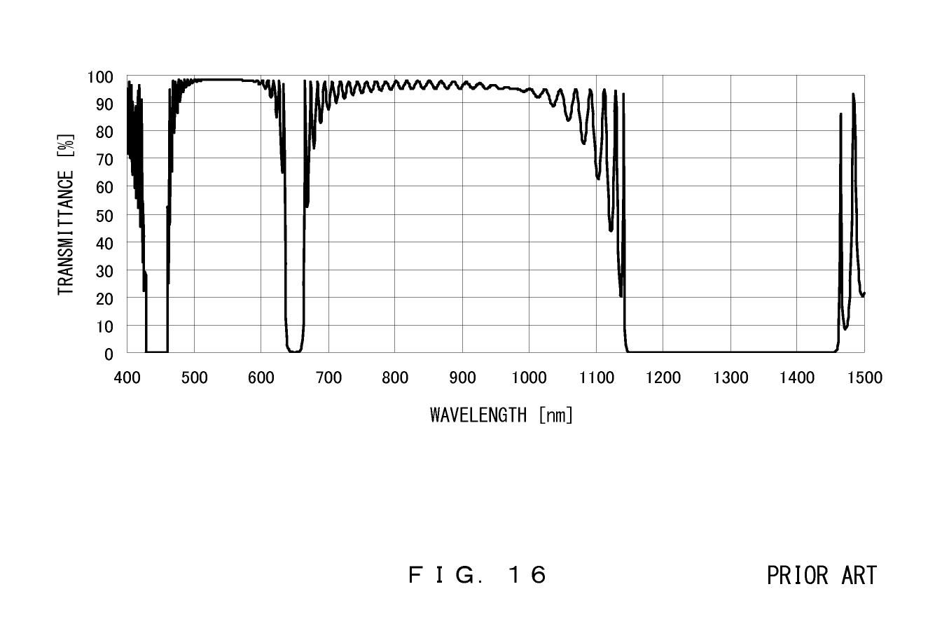

FIG. 16 is a diagram showing a spectral transmittance characteristic of a multilayer filter according to a prior art.

A multilayer filter 60 according to a prior art is a multilayer filter having a multilayer part in which basic configurations each composed of two layers, an H layer and an L layer, are stacked. The materials of the components are similar to the materials of the components of the multilayer filter 20 according to embodiment 1.

The film configuration of the multilayer filter 60 and the design standard wavelength λ₀ are as follows.

Substrate/0.2H 0.4L (2.2H 1.8L)30 2.2H 0.9L/Air

Design standard wavelength λ₀=650 nm (Main reflection wavelength λ_{M}=2λ₀=1300 nm)

As illustrated in FIG. 16, in the multilayer filter 60, a reflection band having a 30 nm reflection width is formed around 650 nm as a second-order reflection band. However, since a main reflection band and a third order reflection band are respectively formed around 1300 nm and 433 nm, the multilayer filter 60 does not have a wide transmission band. As a result, it does not function as a minus filter having a narrow reflection band and a wide transmission band.

By comparing the spectral transmittance characteristic shown in FIG. 16 with the spectral transmittance characteristics in FIGS. 12-15, the utility of the multilayer filters according to embodiments 1-4 will be easily appreciated.

### Embodiment 5

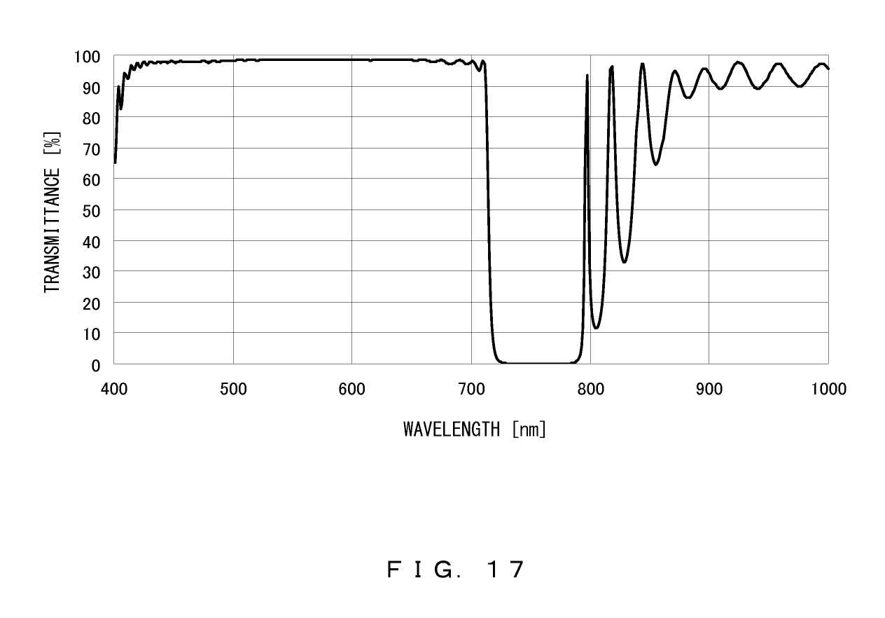

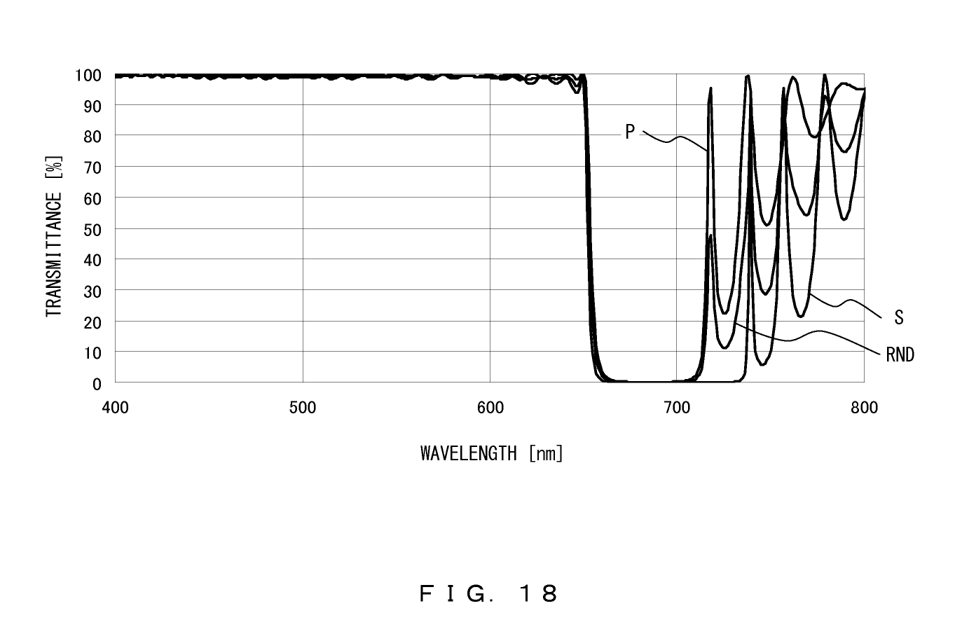

FIG. 17 is a diagram showing a spectral transmittance characteristic of a multilayer filter according to the present embodiment with respect to vertical incident light. FIG. 18 is a diagram showing the spectral transmittance characteristic of the multilayer filter according to the present embodiment with respect to oblique incident light. FIG. 18 shows the spectral transmittance characteristic of the multilayer filter according to the present embodiment with respect to incident light forming a 45° incident angle.

A multilayer filter 70 according to the present embodiment has a configuration similar to that of the multilayer filter 30 according to embodiment 2. The materials of the components are also similar to the materials of the components of the multilayer filter 30 according to embodiment 2.

The film configuration of the multilayer filter 70 and the design standard wavelength λ₀ are as follows.

Substrate/0.109H 0.445L 0.209H 0.339L 0.26H 0.254L 0.372H 0.223L 0.331H 0.342L 0.215H 0.431L 0.289H 0.245L 0.44H 0.278L 0.263H 0.472L 0.255H 0.262L 0.487H 0.233L 0.277H 0.517L 0.195H 0.314L 0.453H 0.188L 0.333H 0.432L 0.183H 0.371L 0.424H 0.19L 0.384H 0.43L 0.178H 0.414L 0.413H 0.191L 0.419H 0.43L (0.195H 0.408L 0.399H 0.196L 0.403H 0.399L)20 0.178H 0.412L 0.371H 0.19L 0.438H 0.4L 0.182H 0.434L 0.351H 0.186L 0.427H 0.366L 0.165H 0.474L 0.306H 0.176L 0.513H 0.276L 0.183H 0.518L 0.228H 0.238L 0.5H 0.204L 0.256H 0.463L 0.221H 0.306L 0.432H 0.198L 0.284H 0.464L 0.199H 0.355L 0.404H 0.158L 0.394H 0.424L 0.193H 0.481L 0.255H 0.21L 0.367H 0.266L 0.29H 0.229L 0.322H 0.201L 0.463H 0.81L/Air

Design standard wavelength λ₀=737 nm (Main reflection wavelength λ_{M}=λ₀/3)

As indicated by the film configuration above, the multilayer part is a structure in which basic configurations are stacked. In the basic configuration, the optical thicknesses of a first layer and a fourth layer are each within a first range r1, the optical thicknesses of a second layer and a fifth layer are each within a second range r2, and the optical thicknesses of a third layer and a sixth layer are each within a third range r3, wherein the optical thicknesses of the first and the second layers, the third and the fourth layers, the fifth and sixth layers are almost equivalent to each other, respectively. Therefore, the multilayer part essentially has a cyclic film-thickness structure in which three layers are defined as one cycle.

A first optical film thickness t1, which is the central value of the optical film thickness within the first range r1, a second optical film thickness t2, which is the central value of the optical film thickness within the second range r2, and a third optical film thickness t3, which is the central value of the optical film thickness within the third range r3, are different from each other; however, the second optical film thickness t2 and the third optical film thickness t3 are almost equal. The total optical film thickness tc of the three layers is about λ₀/4 and the film thickness tb of the basic configuration is about λ₀/2.

The first range r1 is from 0.195λ₀/4 to 0.196λ₀/4, and this range is extremely narrow in comparison with the film thickness. The second range r2 is from 0.403λ₀/4 to 0.408λ₀/4, and this range is extremely narrow in comparison with the film thickness. The third range r3 is 0.399λ₀/4, which is equal to the third optical thickness t3. The ratio of the first range r1 to the second range r2 is about 0.48.

As illustrated in FIG. 17, when vertical light is incident on the multilayer filter 70, a reflection band is formed around 760 nm, which is a wavelength approximately 1.03 times the design standard wavelength λ₀. In the multilayer filter 70, a steep characteristic is indicated in the wavelength range at the short-wavelength-side end of the reflection band; therefore, the multilayer filter 70 has a wavelength separation characteristic which is particularly favorable in the wavelength range.

As shown in FIG. 18, in the multilayer filter 70 according to the present embodiment, when light forming a 45° incident angle is incident, a reflection band is formed around a wavelength on the order of 700 nm. In other words, the spectral transmittance characteristic is moved to the short wavelength side as a whole. In general, when a spectral transmittance characteristic is moved due to such oblique incident light, the steep characteristic in the spectral transmittance characteristic at the end of the reflection band is degraded. This is because the spectral transmittance characteristic with respect to S polarized light is different from that with respect to P polarized light when oblique light is incident.

However, in the multilayer filter 70, as shown in FIG. 18, the characteristic with respect to S polarized light (see line S in FIG. 18) and the characteristic of P polarized light (see line P in FIG. 18) are identical with each other at the short-wavelength-side end of the reflection band. In other words, the optical characteristic with respect to S polarized light and that with respect to P polarized light are not separated at the short-wavelength-side end of the reflection band, and their wavelengths are identical at the end of the reflection band. As a result, even when oblique light is incident, the steepness of the characteristic relative to the total incident light is maintained at the short-wavelength-side end of the reflection band (see line RND in FIG. 18). Therefore, the multilayer filter 70 is preferable as a dichroic mirror placed at a slant relative to incident light.

The reflection bands shown in FIGS. 17 and 18 are new reflection bands which are not formed in multilayer filters according to the prior art. The property in which the wavelengths of S polarized light and P polarized light obtained in the new reflection band are identical at the end of the reflection band is an extremely useful property which is not obtained in multilayer filters according to the prior art. In other words, because of the structure above that is different from those of multilayer filters according to the prior art, the multilayer filter 70 achieves a desired characteristic as a dichroic mirror.

### Embodiment 6

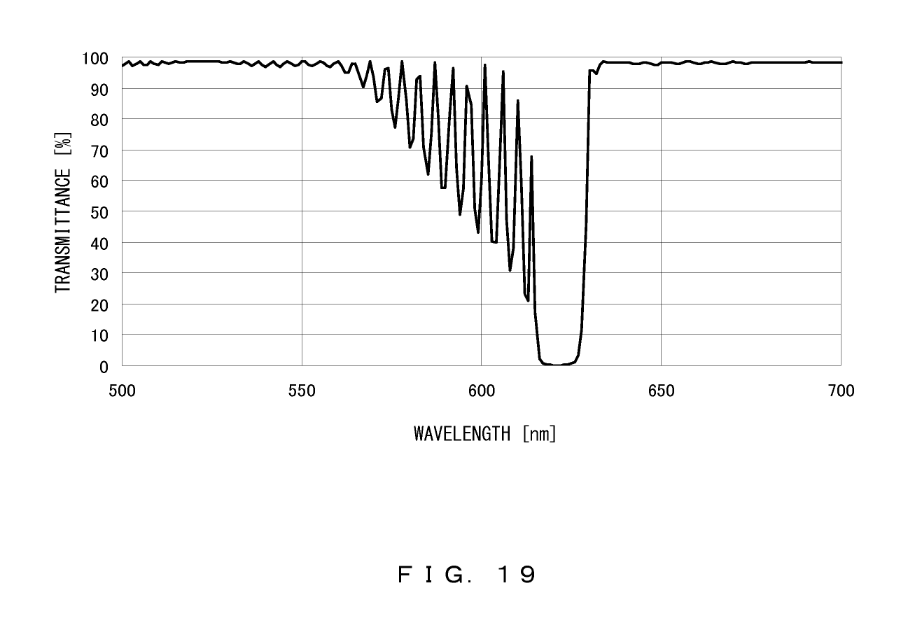

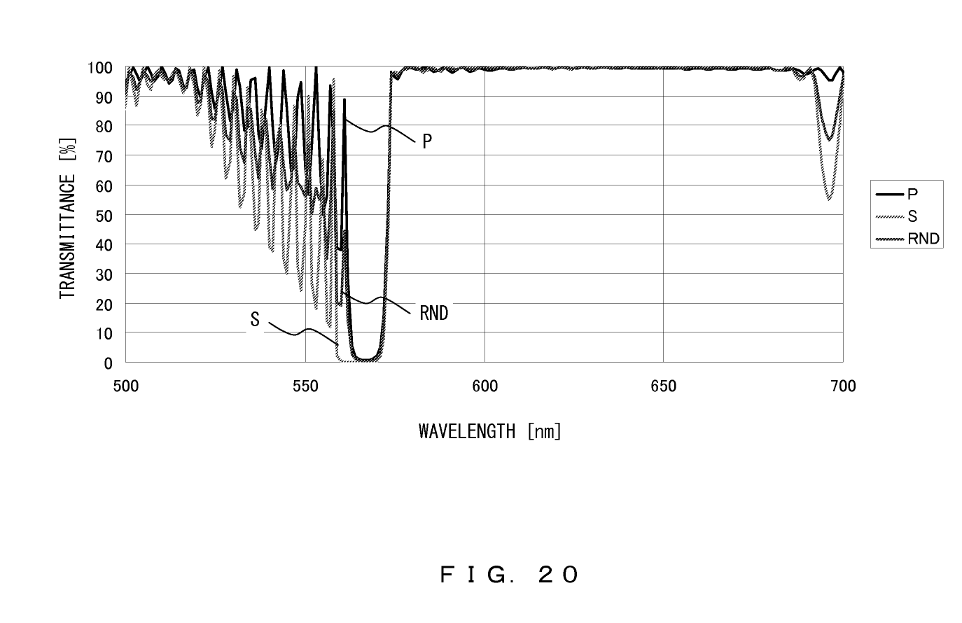

FIG. 19 is a diagram showing a spectral transmittance characteristic of a multilayer filter according to the present embodiment with respect to vertical incident light. FIG. 20 is a diagram showing a spectral transmittance characteristic of the multilayer filter according to the present embodiment with respect to oblique incident light. FIG. 20 shows the spectral transmittance characteristic of the multilayer filter according to the present embodiment with respect to incident light forming a 45° incident angle.

A multilayer filter 80 according to the present embodiment has a configuration similar to that of the multilayer filter 50 according to embodiment 4. The materials of the components are also similar to the materials of the components of the multilayer filter 50 according to embodiment 4.

The film configuration of the multilayer filter 80 and the design standard wavelength λ₀ are as follows.

Substrate/0.131H 0.18L 1.806H 1.724L 1.535H 1.783L 1.568H 1.566L 1.802H 1.46L 1.514H 1.794L 1.504H 1.485L (1.8H 1.6L 1.6H 1.8L 1.6H 1.6L)21 1.817H 1.487L 1.521H 1.802L 1.49H 1.448L 1.802H 1.583L 1.539H 1.774L 1.529H 1.545L 1.557H 0.793L/Air

Design standard wavelength λ₀=625 nm (Main reflection wavelength λ_{M}=5λ₀ /3)

As indicated by the film configuration above, the multilayer part is a structure in which basic configurations are stacked, and has a cyclic film-thickness structure in which three layers are defined as one cycle.

The film thickness tb of the basic configuration and the total optical film thickness tc of the three optical film thicknesses, the first optical film thickness t1, the second optical film thickness t2, and the third optical film thickness t3, are as follows.

t1=1.8λ₀/4, t2=1.6λ₀/4, t3=1.6λ₀/4

tc=5λ₀/4, tb=5λ₀/2

The first optical film thickness t1, the second optical film thickness t2, and the third optical film thickness t3 establish the following relationship.

t2/t1=8/9

t2=t3

As illustrated in FIG. 19, when vertical light is incident on the multilayer filter 80, a reflection band is formed around 621 nm, which is a wavelength approximately 0.99 times the design standard wavelength λ₀. In the multilayer filter 80, a steep characteristic is indicated in the wavelength range at the long-wavelength-side end of the reflection band; therefore, the multilayer filter 80 has a wavelength separation characteristic which is particularly favorable in the wavelength range.

As shown in FIG. 20, in the multilayer filter 80 according to the present embodiment, when light forming a 45° incident angle is incident, the spectral transmittance characteristic is moved to the short wavelength side as a whole; however, the characteristic with respect to S polarized light (see line S in FIG. 20) and the characteristic with respect to P polarized light (see line P in FIG. 20) are identical with each other at the long-wavelength-side end of the reflection band (in the vicinity of 575 nm). In other words, the optical characteristic with respect to S polarized light and that with respect to P polarized light are not separated at the long-wavelength-side end of the reflection band, and their wavelengths are identical at the end of the reflection band. As a result, even when oblique light is incident, the steepness of the characteristic relative to the total incident light is maintained at the long-wavelength-side end of the reflection band (see line RND in FIG. 20). Therefore, the multilayer filter 80 is preferable as a dichroic mirror placed at a slant relative to incident light.

The reflection bands shown in FIGS. 19 and 20 are new reflection bands which are not formed in multilayer filters according to the prior art. The property in which the wavelengths of S polarized light and P polarized light obtained in the new reflection band are identical at the end of the reflection band is an extremely useful property which is not obtained in multilayer filters according to the prior art. In other words, because of the structure above that is different from those of multilayer filters according to the prior art, the multilayer filter 80 achieves a desired characteristic as a dichroic mirror.

### Embodiment 7

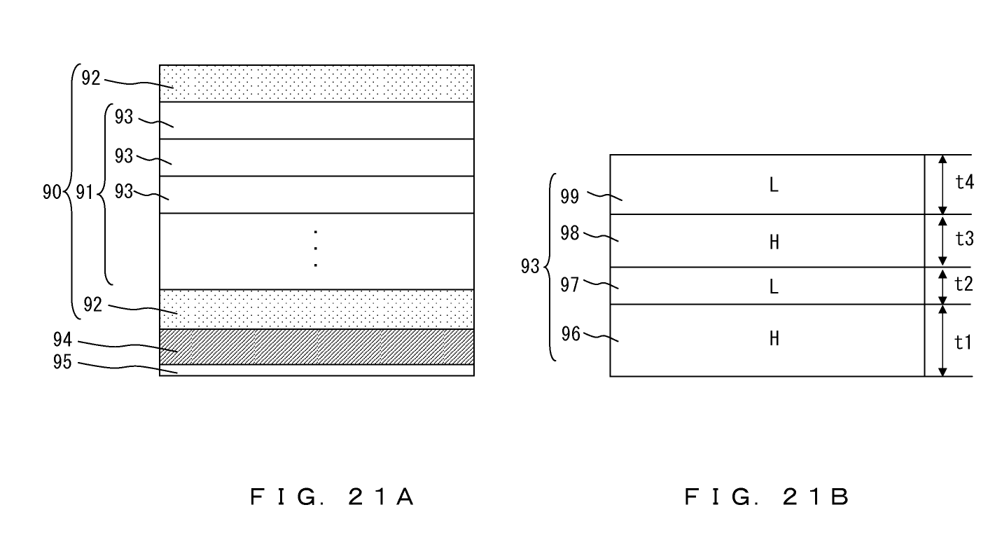

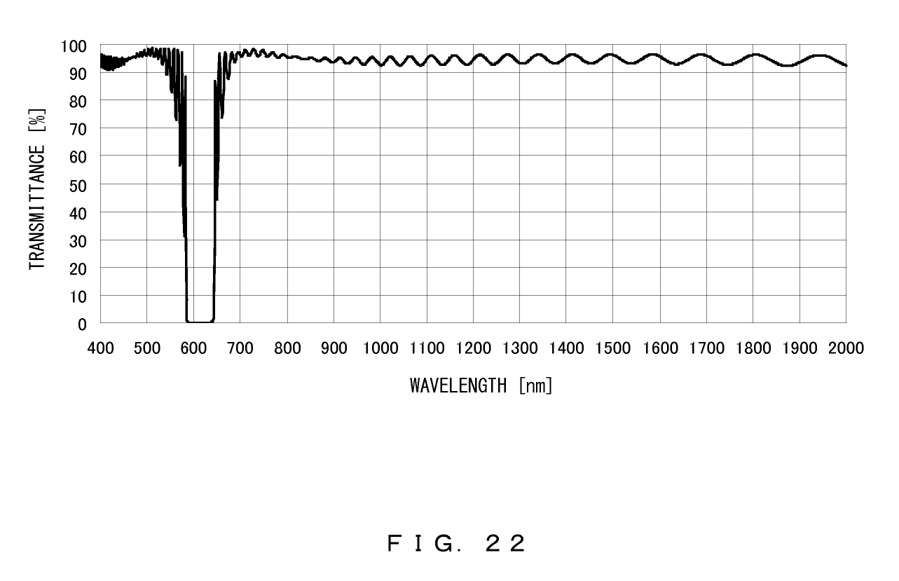

FIG. 21A is a schematic view showing a configuration of a multilayer filter according to the present embodiment. FIG. 21B is a schematic view showing a basic configuration for configuring a multilayer part included in the multilayer filter shown in FIG. 21A. FIG. 22 is a diagram showing a spectral transmittance characteristic of the multilayer filter according to the present embodiment.

As illustrated in FIG. 21A, a multilayer filter 90 according to the present embodiment includes: a multilayer part 91 in which H layers and L layers are stacked in an alternating pattern; and matching parts 92. The multilayer filter 90 is formed on the main film-formation surface of a transparent substrate 94 which is a both-side-polished parallel plate, and an antireflection film 95 is formed on the back side of the substrate 94.

The high refractive index material and the low refractive index material are Ta2O5 and SiO2, respectively. The H layer and the L layer are formed using an ion assisted deposition (IAD). The material of the substrate 94 is BK7, and the antireflection film 95 is a monolayer composed of MgF2.

The film configuration of the multilayer filter 90 and the design standard wavelength λ₀ are as follows.

Substrate/0.288H 0.478L 0.367H 0.531L (0.6H 0.35L 0.4H 0.65L)40 0.326H 0.542L 0.149H 1.946L/Air

Design standard wavelength λ₀=600 nm (Main reflection wavelength λ_{M}=λ₀/2)

As indicated by the film configuration above, the multilayer part 91 is a structure in which basic configurations 93 are stacked, and it has a cyclic film-thickness structure in which four layers are defined as one cycle.

As shown in FIG. 21B, the basic configuration 93 is composed of: a first layer 96 having a first optical film thickness t1; a second layer 97 stacked on the first layer 96 and having a second optical film thickness t2; a third layer 98 stacked on the second layer 97 and having a third optical film thickness t3; and a fourth layer 99 stacked on the third layer 98 and having a fourth optical film thickness t4.

The total optical film thickness tc of the four optical film thicknesses, the first optical film thickness t1, the second optical film thickness t2, the third optical film thickness t3, and the fourth optical film thickness t4, are as follows.

t1=0.6λ₀/4, t2=0.35λ₀/4,

t3=0.4λ₀/4, t4=0.65λ₀/4, tc=λ₀/2

As indicated by the film configuration above, the matching part 92 includes one or more matching layers for suppressing ripples generated around the reflection band of the multilayer filter 90. The matching layer is also composed of a material similar to those of the H layer and the L layer.

As shown in FIG. 22, in the multilayer filter 90 according to the present embodiment, a reflection band having a 63 nm reflection width is formed in the vicinity of the design standard wavelength λ₀ (600 nm). Therefore, the multilayer filter 90 is preferable as a minus filter that has a narrow reflection band and a wide transmission band.

The reflection band formed in the vicinity of 600 nm is a new reflection band which is not formed in multilayer filters according to the prior art. In other words, because of the structure above that is different from that of multilayer filters according to the prior art, the multilayer filter 90 achieves a desired characteristic as a minus filter.

### Embodiment 8

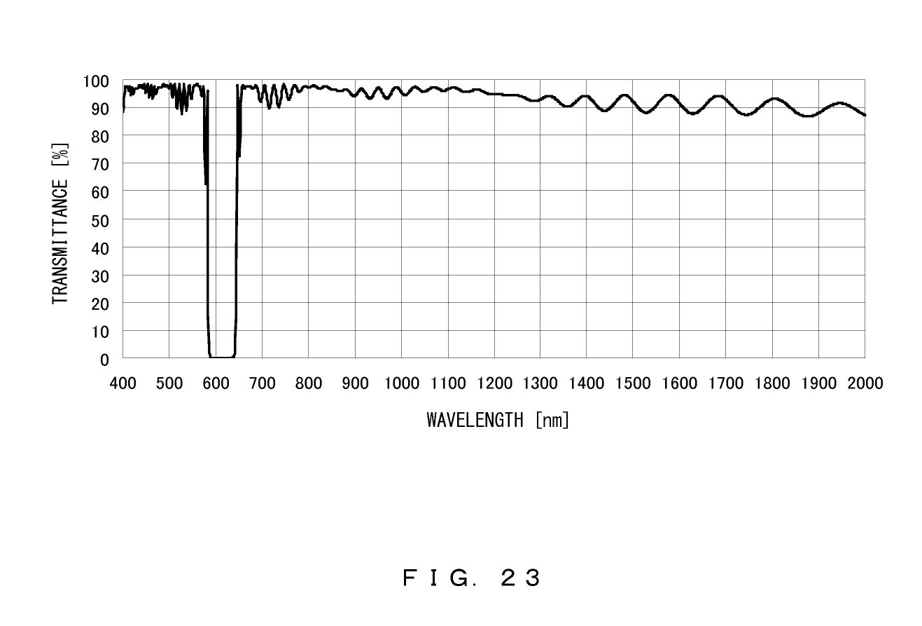

FIG. 23 is a diagram showing a spectral transmittance characteristic of a multilayer filter according to the present embodiment.

A multilayer filter 100 according to the present embodiment has a configuration similar to that of the multilayer filter 90 according to embodiment 7 except for the fact that the multilayer filter 100 has more matching layers included in the matching part in order to further suppress ripples generated around the reflection band. The materials of the components are also similar to the materials of the components of the multilayer filter 90 according to embodiment 7.

The film configuration of the multilayer filter 100 and the design standard wavelength λ₀ are as follows.

Substrate/0.316H 0.54L 0.363H 0.567L 0.641H 0.413L 0.522H 0.435L 0.758H 0.382L 0.524H 0.364L 0.729H 0.282L 0.475H 0.351L (0.6H 0.35L 0.4H 0.65L)34 0.369H 0.573L 0.309H 0.788L 0.399H 0.623L 0.279H 0.851L 0.475H 0.532L 0.494H 0.412L 0.812H 0.429L 0.322H 1.322L/Air

Design standard wavelength λ₀=600 nm (Main reflection wavelength λ_{M}=λ₀/2)

As indicated by the film configuration above, the multilayer part is a structure in which basic configurations are stacked, and has a cyclic film-thickness structure in which four layers are defined as one cycle. The basic configuration is the same as that of the multilayer filter 90 according to embodiment 7.

As shown in FIG. 23, in the multilayer filter 100 according to the present embodiment, a reflection band having a 62 nm reflection width is formed in the vicinity of the design standard wavelength λ₀ (600 nm). Therefore, as with the multilayer filter 90 according to embodiment 7, the multilayer filter 100 is preferable as a minus filter that has a narrow reflection band and a wide transmission band.

In addition, in the multilayer filter 100, since ripples generated in the transmission band proximate to the reflection band are suppressed via fine film-thickness adjustment by the matching layer, the multilayer filter 100 has an improved transmission characteristic in comparison with the multilayer filter 90. Therefore, the multilayer filter 100 has a higher utility.

The reflection band formed in the vicinity of 600 nm is a new reflection band which is not formed in multilayer filters according to the prior art. In other words, because of the structure above different from those of multilayer filters according to the prior art, the multilayer filter 100 achieves a desired characteristic as a minus filter.

### Embodiment 9

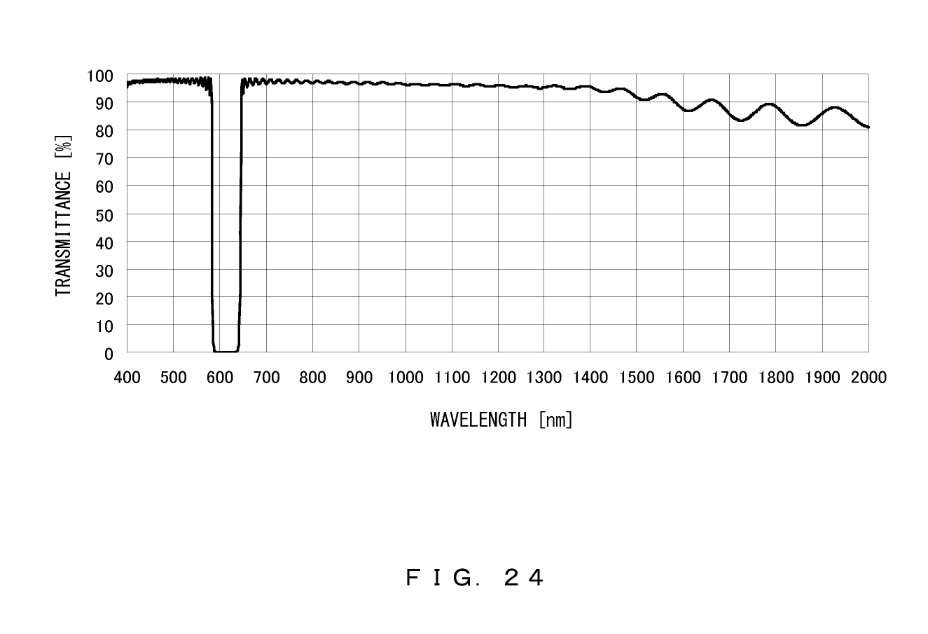

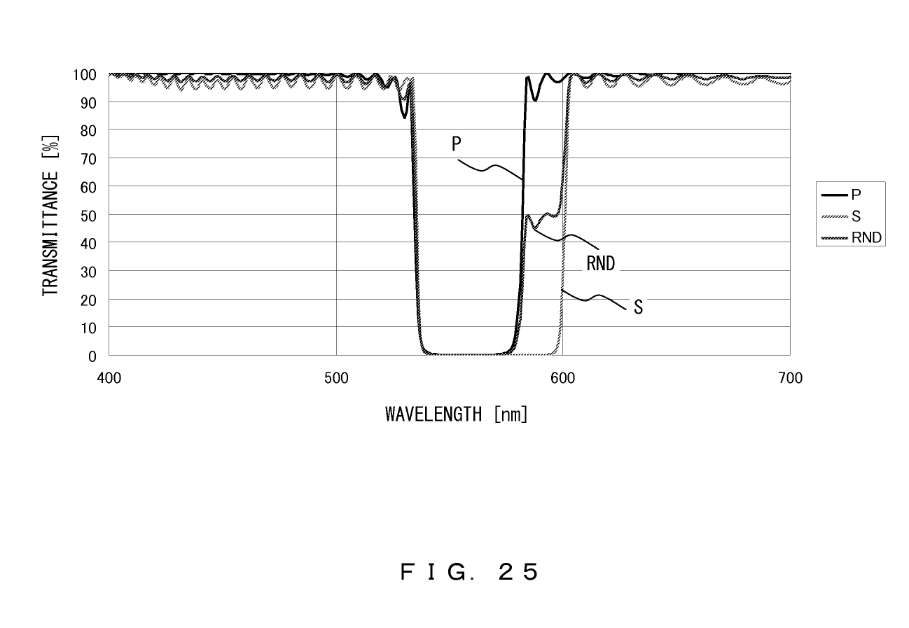

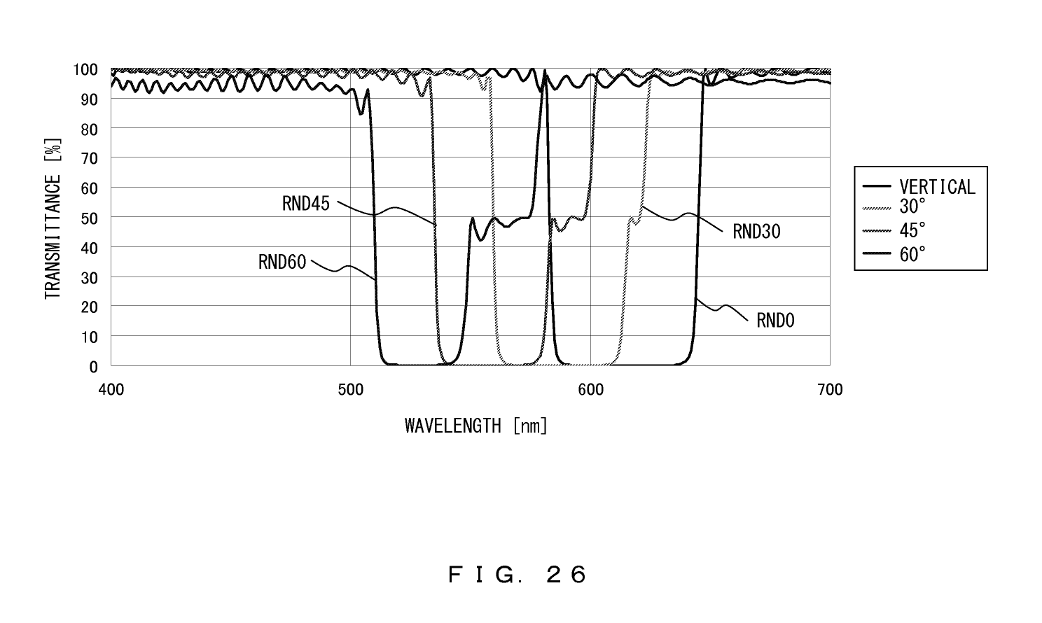

FIG. 24 is a diagram showing a spectral transmittance characteristic of a multilayer filter according to the present embodiment with respect to vertical incident light. FIG. 25 is a diagram showing a spectral transmittance characteristic of the multilayer filter according to the present embodiment with respect to oblique incident light. FIG. 26 is a diagram showing, for a number of incident angles, spectral transmittance characteristics of the multilayer filter according to the present embodiment. FIG. 25 shows the spectral transmittance characteristic with respect to incident light forming a 45° incident angle. FIG. 26 shows the spectral transmittance characteristics with respect to incident light forming a 0° incident angle, incident light forming a 30° incident angle, incident light forming a 45° incident angle, and incident light forming a 60° incident angle.

A multilayer filter 110 according to the present embodiment has a configuration similar to that of the multilayer filter 100 according to embodiment 8 except for the fact that the multilayer filter 110 does not have a strictly cyclic film-thickness structure but has a loosely cyclic film-thickness structure in order to further suppress ripples generated around the reflection band. The materials of the components are also similar to the materials of the components of the multilayer filter 100 according to embodiment 8.

The film configuration of the multilayer filter 110 and the design standard wavelength λ₀ are as follows.

Substrate/0.248H 0.592L 0.353H 0.543L 0.633H 0.392L 0.551H 0.406L 0.755H 0.374L 0.505H 0.399L 0.703H 0.368L 0.442H 0.443L 0.641H 0.4L 0.406H 0.551L 0.6H 0.438L 0.388H 0.558L 0.627H 0.393L 0.399H 0.535L 0.627H 0.357L 0.404H 0.57L 0.6H 0.357L 0.407H 0.629L 0.586H 0.37L 0.41H 0.638L 0.593H 0.362L 0.405H 0.639L 0.593H 0.357L 0.404H 0.644L 0.596H 0.356L 0.403H 0.647L 0.599H 0.352L 0.401H 0.647L 0.598H 0.35L 0.4H 0.651L 0.602H 0.349L 0.4H 0.651L 0.601H 0.348L 0.398H 0.653L 0.602H 0.347L 0.398H 0.654L 0.603H 0.346L 0.397H 0.654L 0.603H 0.345L 0.397H 0.655L 0.604H 0.345L 0.397H 0.655L 0.604H 0.344L 0.397H 0.655L 0.604H 0.344L 0.397H 0.655L 0.605H 0.344L 0.397H 0.655L 0.604H 0.344L 0.397H 0.654L 0.604H 0.345L 0.399H 0.654L 0.604H 0.346L 0.398H 0.652L 0.602H 0.346L 0.4H 0.651L 0.603H 0.347L 0.401H 0.65L 0.6H 0.35L 0.4H 0.648L 0.601H 0.35L 0.404H 0.645L 0.598H 0.354L 0.403H 0.646L 0.593H 0.357L 0.407H 0.635L 0.592H 0.355L 0.399H 0.656L 0.517H 0.379L 0.385H 0.687L 0.51H 0.374L 0.432H 0.676L 0.528H 0.4L 0.413H 0.676L 0.529H 0.382L 0.45H 0.591L 0.573H 0.397L 0.407H 0.771L 0.395H 0.676L 0.251H 0.79L 0.56H 0.406L 0.615H 0.262L 1.022H 0.375L 0.336H 1.254L/Air

Design standard wavelength λ₀=600 nm (Main reflection wavelength λ_{M}=On the order of λ₀/2)

As indicated by the film configuration above, since the multilayer filter 110 does not have a strictly cyclic film-thickness structure, a distinction is not clear between a multilayer part and a matching part. However, the multilayer filter 110 essentially has a cyclic film-thickness structure in which four layers are defined as one cycle.

In other words, in the multilayer filter 110, a basic configuration can be found which is composed of: a first layer having an optical film thickness within a first range r1; a second layer stacked on the first layer and having an optical film thickness within a second range r2; a third layer stacked on the second layer and having an optical film thickness within a third range r3; and a fourth layer stacked on the third layer and having an optical film thickness within a fourth range r4.

A first optical film thickness t1, which is the central value of the optical thickness within the first range r1, a second optical film thickness t2, which is the central value of the optical film thickness within the second range r2, a third optical film thickness t3, which is the central value of the optical film thickness within the third range r3, and a fourth optical film thickness t4, which is the central value of the optical film thickness within the fourth range r4, are different from each other. The total optical film thickness tc of the four layers is about λ₀/2.

As shown in FIG. 24, when vertical light is incident on the multilayer filter 110, a reflection band having a 62 nm reflection width is formed in the vicinity of the design standard wavelength λ₀ (600 nm). Therefore, as with the multilayer filter 90 according to embodiment 7, the multilayer filter 110 is preferable as a minus filter that has a narrow reflection band and a wide transmission band.

In addition, in the multilayer filter 110, since ripples generated in the transmission band proximate to the reflection band are suppressed via fine film-thickness adjustment by the loosely cyclic film-thickness structure, the multilayer filter 110 has an improved transmission characteristic in comparison with the multilayer filter 90. Therefore, the multilayer filter 110 has a higher utility.

As shown in FIG. 25, in the multilayer filter 110, when light forming a 45° incident angle is incident, the spectral transmittance characteristic is moved to the short wavelength side as a whole in comparison with the situation in which vertical light is incident. The spectral transmittance characteristic with respect to S polarized light is different from that with respect to P polarized light.

However, in the multilayer filter 110, the characteristic with respect to S polarized light (see line S in FIG. 25) and that with respect to P polarized light (see line P in FIG. 25) are not separated at the short-wavelength-side end of the reflection band, and their wavelengths are identical at the end of the reflection band. In other words, the wavelength of S polarized light and that of P polarized light are identical at the end of the reflection band. As a result, even when light forming a 45° incident angle is incident, the steepness of the characteristic relative to the total incident light is maintained at the short-wavelength-side end of the reflection band (see line RND in FIG. 25).

As shown in FIG. 26, such a property is maintained irrespective of incident angles. In other words, all of the spectral transmittance characteristics with respect to light forming a 0° incident angle, light forming a 30° incident angle, light forming a 45° incident angle, and light forming a 60° incident angle (see line RND0, line RND30, line RND45, and line RND60 in FIG. 26, respectively) are steep at the short-wavelength-side ends of the reflection bands.

Therefore, the multilayer filter 110 is preferable as a dichroic mirror placed at a slant relative to incident light. The multilayer filter 110 is also preferable as a minus filter that can change a reflection wavelength.

The reflection bands shown in FIGS. 24, 25 and 26 are new reflection bands which are not formed in multilayer filters according to the prior art. The property in which the wavelengths of S polarized light and P polarized light obtained in the new reflection band are identical at the end of the reflection band is an extremely useful property which is not obtained in multilayer filters according to the prior art. In other words, because of the structure above that is different from that of multilayer filters according to the prior art, the multilayer filter 110 achieves desired characteristics as both a minus filter and a dichroic mirror.

### Embodiment 10

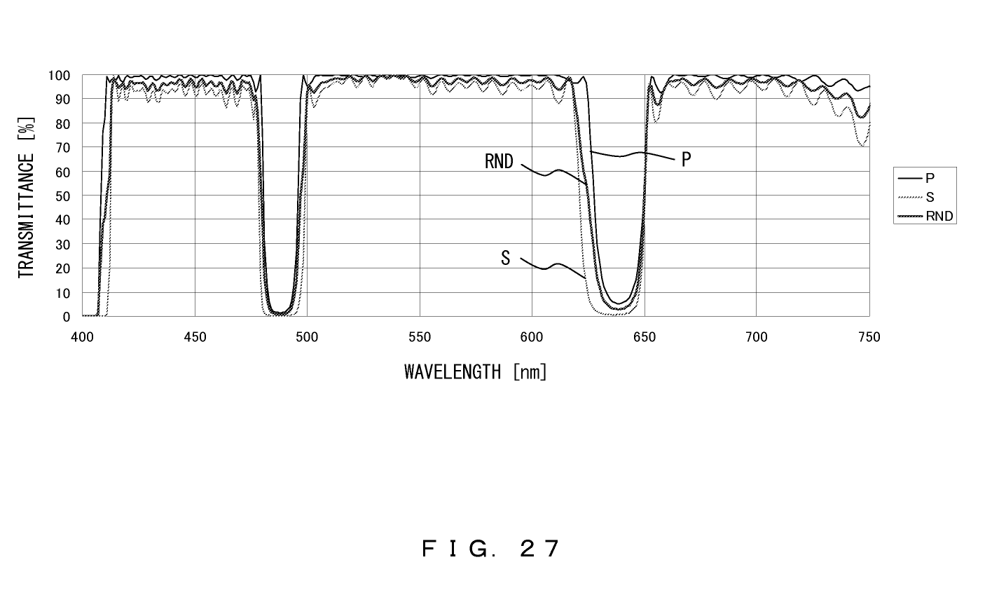

FIG. 27 is a diagram showing a spectral transmittance characteristic of a multilayer filter according to the present embodiment with respect to oblique incident light. FIG. 27 shows a spectral transmittance characteristic with respect to incident light forming a 45° incident angle.

A multilayer filter 120 according to the present embodiment has a configuration similar to that of the multilayer filter 70 according to embodiment 7 except for the facts that the multilayer filter 120 has more matching layers included in the matching part in order to further suppress ripples generated around the reflection band and that an antireflection film formed on the backside of the substrate prevents the reflection of light within a visible light range forming a 45° incident angle. The materials of the components are also similar to the materials of the components of the multilayer filter 90 according to embodiment 7.

The film configuration of the multilayer filter 120 and the design standard wavelength λ₀ are as follows.

Substrate/0.131H 0.223L 1.065H 1.115L 0.908H 1.06L 0.932H 1.07L 0.851H 1.095L 0.964H 1.11L 0.84H 1.133L 0.968H 1.097L 0.781H 1.14L 0.982H 1.102L 0.769H 1.169L (1H 1.1L 0.7H 1.2L)10 0.995H 1.099L 0.725H 1.169L 0.994H 1.084L 0.758H 1.152L 0.982H 1.091L 0.824H 1.137L 0.969H 1.033L 0.816H 1.043L 0.865H 1.064L 0.936H 1.697L/Air

Design standard wavelength λ₀=1050 nm (Main reflection wavelength λ_{M}=λ₀)

As indicated by the film configuration above, the multilayer part is a structure in which basic configurations are stacked, and has a cyclic film-thickness structure in which four layers are defined as one cycle.

As shown in FIG. 27, in the multilayer filter 120, narrow reflection bands are formed in the vicinity of 400 nm, 490 nm, and 640 nm. At at least one end of each of the reflection bands, the characteristic with respect to S polarized light and that with respect to P polarized light are identical with each other. As a result, the steepness of characteristic relative to the entirety of incident light is maintained at at least one end of the reflection band.

Therefore, the multilayer filter 120 is preferable as a multiband dichroic mirror that reflects laser light from a 405 nm laser, a 488 nm laser, and a 638 nm laser, all of which are widely used, and that allows passage of light of other bandwidths. The lasers for the three wavelengths above are lasers which are most generally used in the field of biology. Accordingly, the multilayer filter 120 is particularly suitable as a multiband dichroic mirror used for an analytical instrument for which fluorescent dye is used.

When vertical light is incident, a main reflection band is formed proximate to the design standard wavelength λ₀ (1050 nm), and when light forming a 45° incident angle is incident, a main reflection band is formed in the vicinity of 960 nm. This means that the reflection bands in FIG. 27 formed in the vicinity of 400 nm and 640 nm are new reflection bands which are not formed in multilayer filters according to the prior art. The reflection band formed in the vicinity of 490 nm corresponds to a second order reflection band. In other words, because of the structure above that is different from that of multilayer filters according to the prior art, the multilayer filter 120 also achieves a desired characteristic as a multiband dichroic mirror.

### Embodiment 11

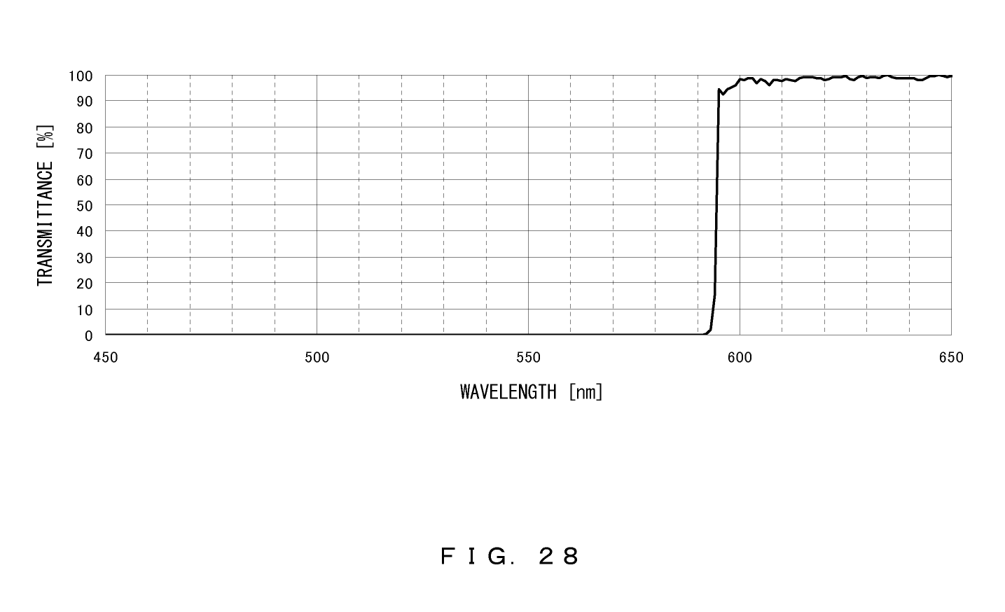

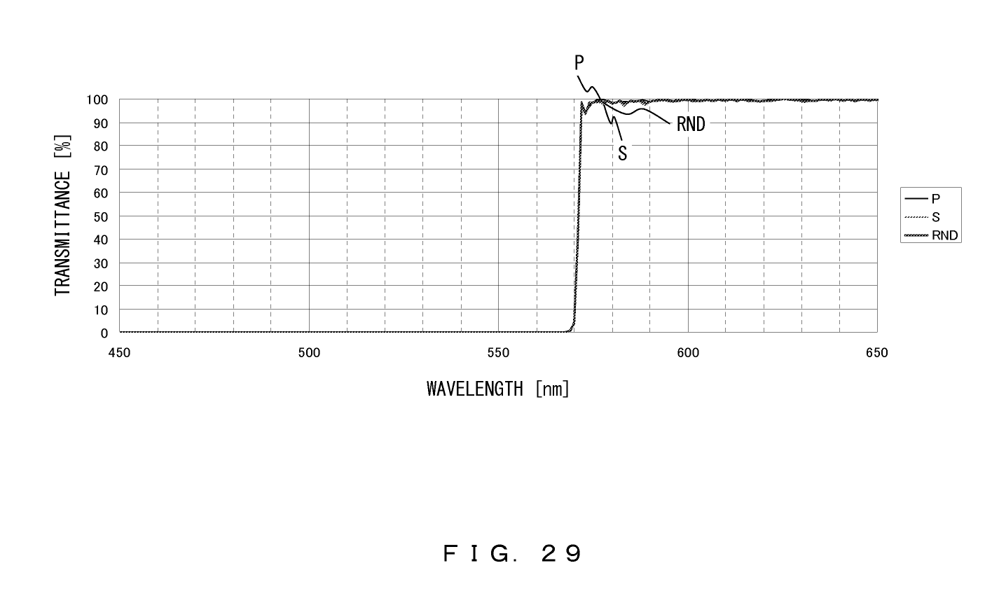

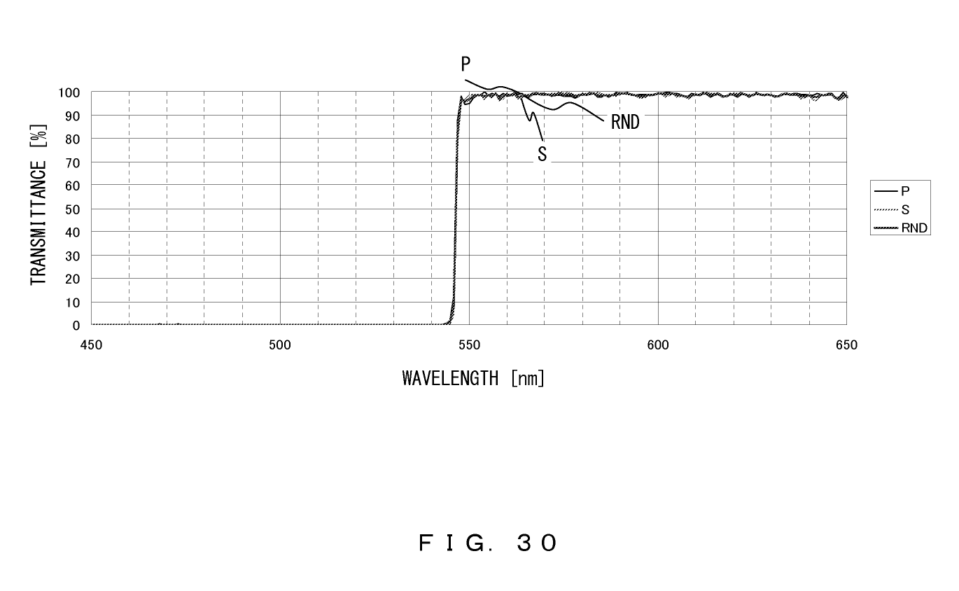

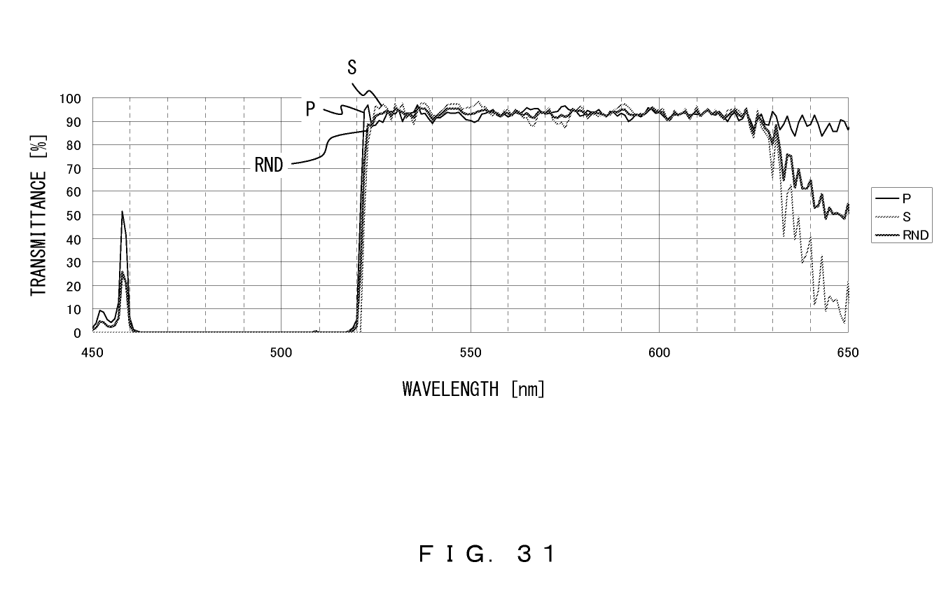

FIG. 28 is a diagram showing a spectral transmittance characteristic of an optical component according to the present embodiment with respect to vertical incident light. FIGS. 29, 30 and 31 are diagrams each showing a spectral transmittance characteristic of an optical component according to the present embodiment with respect to oblique incident light. FIGS. 29, 30 and 31 show spectral transmittance characteristics with respect to light forming a 30° incident angle, light forming a 45° incident angle, and light forming a 60° incident angle, respectively.

An optical component 130 according to the present embodiment includes a first multilayer filter and a second multilayer filter, wherein a transparent substrate, which is a both-side-polished parallel plate, is sandwiched between the first and second multilayer filters.

The first and second multilayer filters each includes: a plurality of multilayer parts in which H layers and L layers are stacked in an alternating pattern; and a matching part. The first multilayer filter includes: a multilayer part having a cyclic film-thickness structure in which four layers are defined as one cycle; and a multilayer part having a cyclic film-thickness structure in which two layers are defined as one cycle. Meanwhile, the second multilayer filter includes only a multilayer part having a cyclic film-thickness structure in which two layers are defined as one cycle. This means that the first multilayer filter is the multilayer filter according to the present embodiment, and the second multilayer filter is a multilayer filter according to a prior art.

The high refractive index material and the low refractive index material are Ta2O5 and SiO2, respectively. The H layer and the L layer are formed using an ion assisted deposition (IAD). The material of the substrate is synthetic quartz (BK7).

The film configuration of the first multilayer filter and the design standard wavelength λ₁ are as follows.

Substrate/1.167H 1.123L 0.977H 0.927L 1.056H 1.057L 0.911H 0.889L 1.064H 1.096L 0.888H 0.82L 1.125H 1.056L 0.961H 0.737L (1.16H 1.026L 1.026H 0.8L)34 1.192H 1.005L 0.917H 1.019L 1.119H 0.976L 1.062H 1.078L 1.25H 1.137L 1.409H 1.199L 1.41H 1.158L 1.424H 1.124L (1.433H 1.136L)28 1.405H 1.093L 1.411H 1.175L 1.396H 1.188L 1.345H 1.153L 1.279H 1.329L 1.305H 1.285L 1.08H 1.42L 1.845H 0.812L/Air

Design standard wavelength λ₁=870 nm

The film configuration of the second multilayer filter and the design standard wavelength λ₂ are as follows.

Substrate/2.557H 1.73L 0.456H 0.736L 1.138H 0.794L 0.903H 0.901L (0.89H 0.905L)8 0.882H 0.905L 0.964H 0.84L 0.779H 1.047L 3.064H 1.055L 2.94H 1.092L 2.989H 1.073L 2.986H 1.085L (3H 1.1L)12 2.979H 1.097L 2.953H 1.167L 2.88H 1.214L 2.778H 1.366L 2.498H 1.833L 2.914H 0.439L 3.521H 1.448L/Air

Design standard wavelength λ₂=522 nm

As indicated by the film configurations above, the matching parts of the first and second multilayer filters each include many matching layers in order to suppress ripples generated around the reflection band.

As shown in FIG. 28, in the optical component 130, a steep spectral transmittance characteristic is achieved for allowing passage of only long wavelengths. In addition, as shown in FIGS. 29-31, even when oblique light is incident on the optical component 130, the difference between the spectral transmittance characteristics with respect to P polarized light and S polarized light is extremely small. Therefore, the optical component 130 is also preferable as both a dichroic mirror placed at a slant relative to incident light and a long pass filter.

Such a property cannot be achieved by the second multilayer filter, which is a multilayer filter according to a prior art. The property is mainly achieved by the first multilayer filter including a multilayer part having a cyclic film-thickness structure in which four layers are defined as one cycle. In other words, because of the structure above that is different from that of multilayer filters according to the prior art, the optical component 130 also achieves desired characteristics as both a dichroic mirror and a long pass filter.

In the following, fluorescent microscopes using the aforementioned multilayer filters disclosed by embodiments 1-11 will be described.

### Embodiment 12

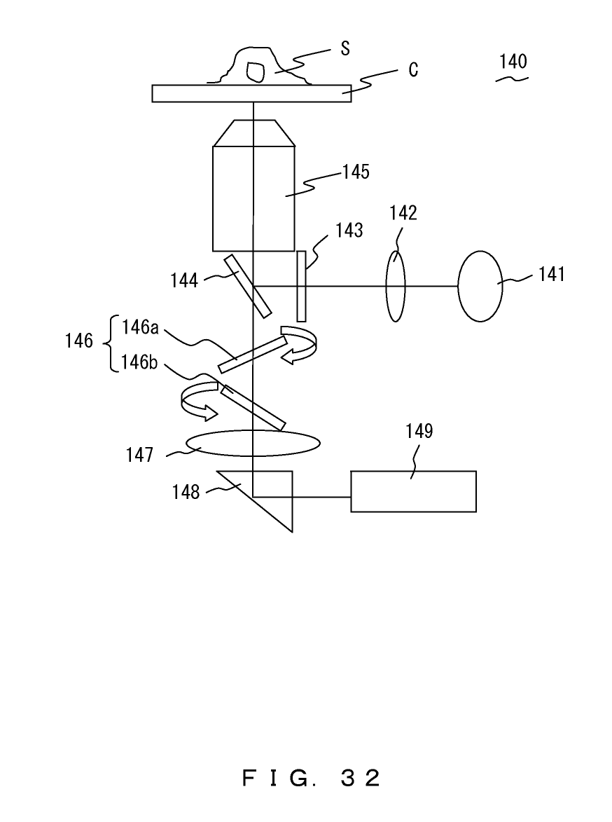

FIG. 32 is a schematic view showing a configuration of a fluorescent microscope according to the present embodiment. A fluorescent microscope 140 illustrated in FIG. 32 is a fluorescent microscope in which multilayer filters (a multilayer filter 146a and a multilayer filter 146b) as disclosed in the embodiments described above are placed in an observation light path, the multilayer filters including a multilayer part having a cyclic film-thickness structure in which three or more layers are defined as one cycle. The detection wavelength range of the fluorescent microscope 140 and its width can be optionally changed depending on the multilayer filter.

The fluorescent microscope 140 includes: a light source 141 for emitting excitation light; an illumination lens 142; an excitation filter 143; a dichroic mirror 144 for reflecting excitation light and for allowing passage of fluorescence; an objective 145 for irradiating a sample S with excitation light; a multilayer filter group 146 (the multilayer filters 146a and 146b); a lens 147; a prism 148; and a camera 149.

The multilayer filters 146a and 146b configuring the multilayer filter group 146 are each placed so that the inclination relative to the optical axis can be changed. The multilayer filters 146a and 146b each have a cyclic film-thickness structure in which three or more layers are defined as one cycle, and this enables the transmission band to be moved while maintaining the steepness of the spectral transmittance characteristic by changing the incident angle. Using this property, the entirety of the multilayer filter group 146 functions as a bandpass filter that can optionally change a wavelength range in which a transmission band is formed and the width of this wavelength range.

As the sample S, a relatively thick sample is used, such as zebra fish, a drosophila, a tissue slice, or a brain slice used in, for example, outbreak/reproduction investigations.

Excitation light emitted from the light source 141 is converted into essentially parallel light fluxes by the illumination lens 142 and is then incident on the excitation filter 143. The excitation filter 143 selectively allows pas sage of only light within a wavelength range required to excite a fluorescent material in the sample S. As a result of this, only the light within the wavelength range required for the excitation is applied to the sample S via the dichroic mirror 144, the objective 145, and a cover glass C, thereby exciting the fluorescent material.

Fluorescence generated from the fluorescent material in the Sample S is incident on the dichroic mirror via the objective 145. The dichroic mirror 144 reflects excitation light which has been reflected from the sample S and the like and which is incident together with the fluorescence, and allows passage of only the fluorescence. However, the fluorescence contains fluorescence not from the sample S (intrinsic fluorescence).

The intrinsic fluorescence contained in the fluorescence incident on the multilayer filter 146 is efficiently removed by the multilayer filter group 146. Then, the fluorescence from which the intrinsic fluorescence was removed is incident on the camera 149 via the lens 147 and the prism 148, and a fluorescence image is formed by a signal of a favorable S/N.

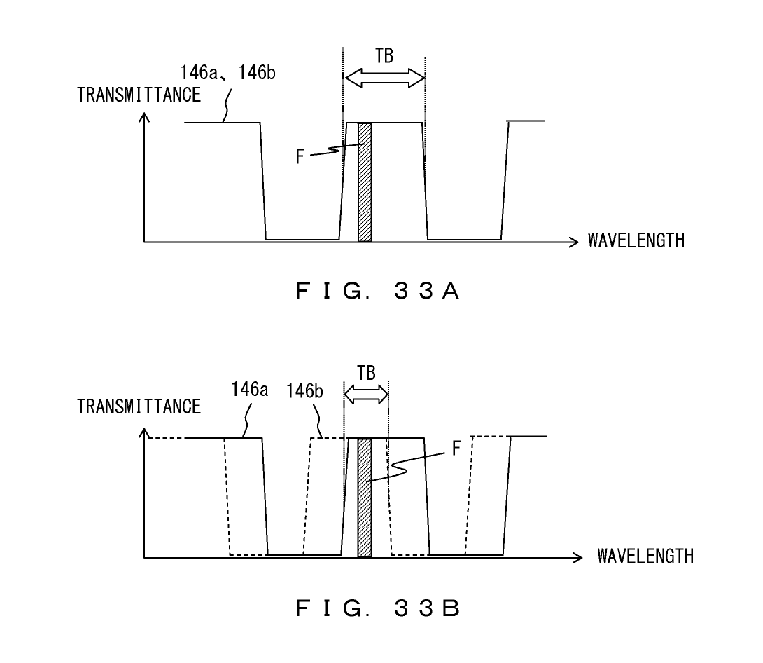

In the following, with reference to FIGS. 33A and 33B, a method for removing intrinsic fluorescence used by the multilayer filter group 146 will be specifically described.

FIGS. 33A and 33B are diagrams showing spectral transmittance characteristics of a multilayer filter 146a and a multilayer filter 146b which function as a bandpass filter. FIG. 33A shows a characteristic under a situation in which the multilayer filters 146a and 146b are placed vertically to the optical axis. FIG. 33B shows a characteristic under a situation in which one of the multilayer filters 146a and 146b is placed at a slant relative to the optical axis.

For simplicity, FIGS. 33A and 33B show a situation in which the multilayer filters 146a and 146b have the same spectral transmittance characteristic; however, the configuration is not particularly limited to this. The multilayer filters 146a and 146b may have different spectral transmittance characteristics.

As illustrated in FIG. 33A, when the multilayer filters 146a and 146b are placed vertically to the optical axis, their spectral transmittance characteristics are identical with each other, and hence a transmission band TB of the entirety of the multilayer filter group 146 is identical with the transmission band of each of the multilayer filters 146a and 146b.

Meanwhile, as illustrated in FIG. 33B, when one of the multilayer filters 146a and 146b (here, the multilayer filter 146b) is placed at a slant relative to the optical axis, the characteristic of the multilayer filter (the multilayer filter 146b) is moved to the short wavelength side, and hence their spectral transmittance characteristics are not identical with each other. The transmission band TB of the entirety of the multilayer filter group 146 is only a wavelength range in which the transmission band of the multilayer filter 146a and that of the multilayer filter 146b overlap with each other; accordingly, the transmission band becomes narrow.

As described above, by adjusting the inclinations of the multilayer filters 146a and 146b, a transmission band having an optional bandwidth can be formed in an optional wavelength range. In comparison with fluorescence to be detected which has a certain wavelength range F, intrinsic fluorescence usually has a broader wavelength range. Accordingly, by controlling the width of the transmission band and the position at which it is formed, intrinsic fluorescence can be removed efficiently.

Accordingly, the fluorescent microscope 140 according to the present embodiment enables intrinsic fluorescence to be removed efficiently. Therefore, a fluorescence image that includes a small amount of noise can be formed.

Here, an example was given in which only one of the multilayer filters is inclined; however, the configuration is not particularly limited to this. Both of the multilayer filters may be inclined. By inclining both of the multilayer filters, a transmission band having an optional bandwidth can be formed in an optional wavelength range without being limited to the formation in a transmission band that is formed when the multilayer filters are placed vertically to the optical axis.

Here, an example was given in which two multilayer filters are used; however, the configuration is not particularly limited to this. Only one multilayer filter may be used. Also in this case, a transmission band can be formed in an optional wavelength range. However, it is desirable that a multilayer filter having a transmission bandwidth optimized in advance be provided, although the bandwidth cannot be controlled.

### Embodiment 13

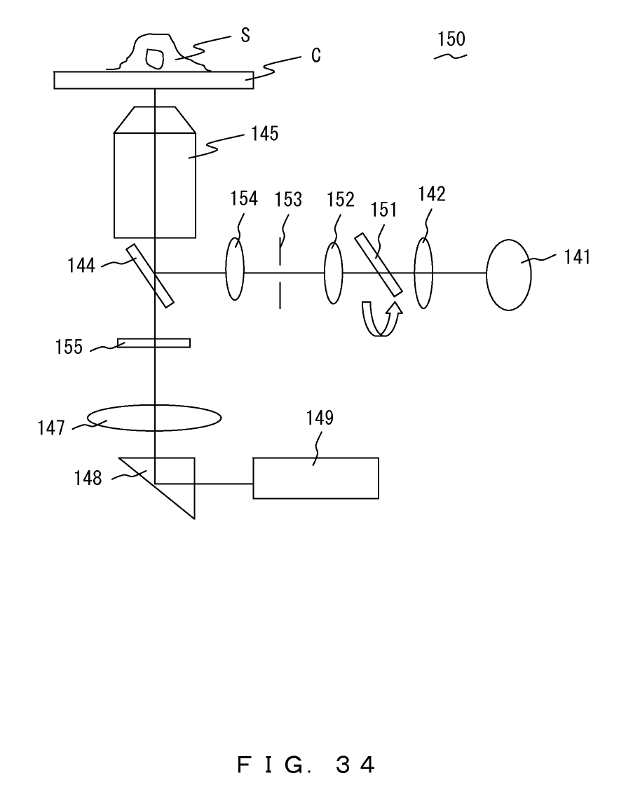

FIG. 34 is a schematic view showing a configuration of a fluorescent microscope according to the present embodiment. In a fluorescent microscope 150 illustrated in FIG. 34, a multilayer filter 151 is placed in an illumination light path, wherein the multilayer filter 151 includes a multilayer part having a cyclic film-thickness structure in which three or more layers are defined as one cycle. The multilayer filter 151 functions as an excitation filter.

The fluorescent microscope 150 includes: a light source 141 for emitting excitation light; an illumination lens 142; a multilayer filter 151; a lens 152; a field stop 153; a lens 154; a dichroic mirror 144 for reflecting excitation light and allowing passage of fluorescence; an objective 145 for irradiating a sample S with excitation light; a barrier filter 155; a lens 147; a prism 148; and a camera 149.

The multilayer filter 151 is placed so that the inclination relative to the optical axis can be changed. The multilayer filter 151 has a cyclic film-thickness structure in which three or more layers are defined as one cycle, and this enables the transmission band to be moved while maintaining the steepness of the spectral transmittance characteristic by changing the incident angle.

In general, the border portion between a reflection band and a transmission band (hereinafter referred to as a rising wavelength range) in a dichroic mirror or a barrier filter has some width (hereinafter referred to as a tolerance). Accordingly, a fluorescent filter set (a dichroic mirror, a barrier filter, and an excitation filter) is designed in consideration of the tolerance. As a result, excitation filters are usually designed on the assumption that there is a large tolerance, so that they can be used for various dichroic mirrors and barrier filters. Therefore, there will be an unnecessarily large interval between a transmission band in a dichroic mirror or a barrier filter and a transmission band in an excitation filter, and, as a result of this, the lighting efficiency of excitation light is decreased.

However, in the fluorescent microscope 150 according to the present embodiment, by changing the inclination of the multilayer filter 151 relative to the optical axis, the transmission band of the multilayer filter 151 can be moved while maintaining the steepness of the spectral transmittance characteristic. As a result of this, the intervals between the transmission bands of the dichroic mirror 144, the barrier filter 155, and the multilayer filter 151 can be minimized.

Therefore, the fluorescent microscope 150 according to the present embodiment can improve the lighting efficiency of excitation light and can form brighter fluorescence images.

### Embodiment 14

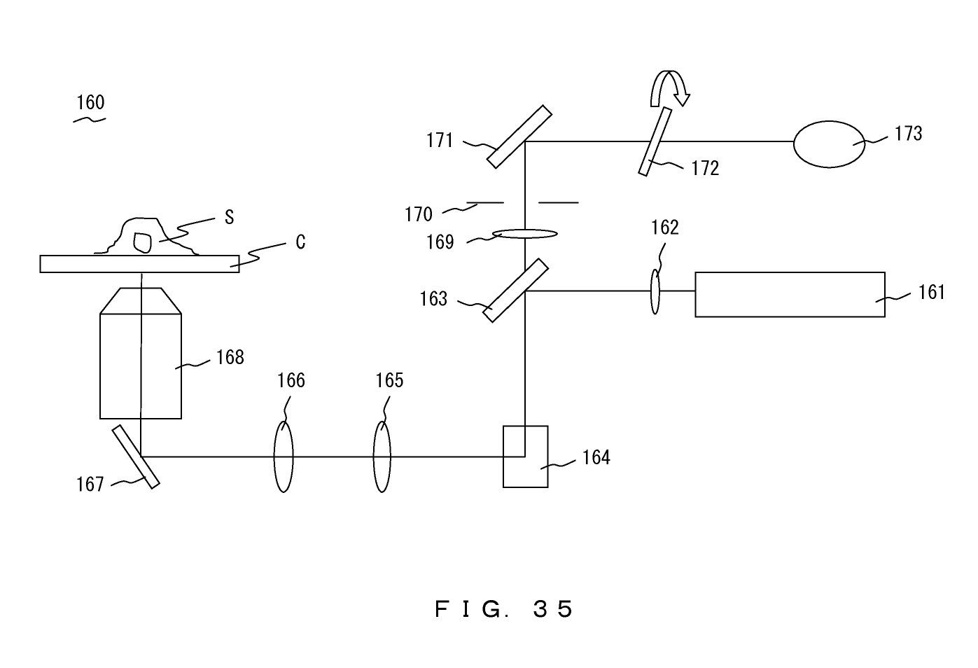

FIG. 35 is a schematic view showing a configuration of a fluorescent microscope according to the present embodiment. In a fluorescent microscope 160 illustrated in FIG. 35, a multilayer filter 172 is placed in a detection light path, wherein the multilayer filter 172 includes a multilayer part having a cyclic film-thickness structure in which three or more layers are defined as one cycle. The multilayer filter 172 functions as a bandpass filter.

The fluorescent microscope 160 is a confocal scanning laser microscope including: a laser 161; a collimator lens 162; a dichroic mirror 163 for reflecting laser light and allowing passage of fluorescence; a galvanometer mirror 164 for scanning a sample S; a pupil-projection lens 165; a tube lens 166; a mirror 167; an objective 168 for irradiating the sample S with excitation light; a confocal lens 169 for collecting fluorescence; a confocal stop 170 having a pinhole at the focal position of the confocal lens 169; a mirror 171; a multilayer filter 172; and a photomultiplier 173.

The multilayer filter 172 is placed so that the inclination relative to the optical axis can be changed. The multilayer filter 172 has a cyclic film-thickness structure in which three or more layers are defined as one cycle, and this enables the transmission band to be moved while maintaining the steepness of the spectral transmittance characteristic by changing the incident angle.

Accordingly, by changing the inclination of the multilayer filter 172 relative to the optical axis, the fluorescent microscope 160 can effectively separate fluorescence having various fluorescence wavelengths from excitation light.

Therefore, the fluorescent microscope 160 according to the present embodiment can deal with various fluorescent materials in which each has a different fluorescence wavelength without the bandpass filter being replaced.

### Embodiment 15

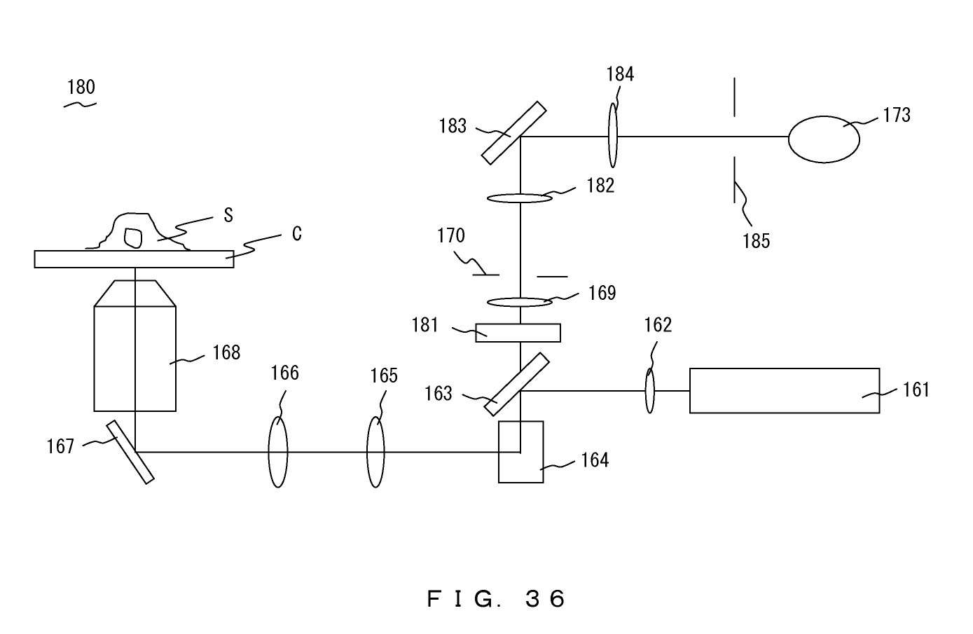

FIG. 36 is a schematic view showing a configuration of a fluorescent microscope according to the present embodiment. In a fluorescent microscope 180 illustrated in FIG. 36, a multilayer filter 181 is placed in a detection light path, wherein the multilayer filter 181 includes a multilayer part having a cyclic film-thickness structure in which three or more layers are defined as one cycle. The multilayer filter 181 functions as a minus filter (notch filter) having an extremely narrow transmission band.

The fluorescent microscope 180 is a confocal scanning laser microscope having a spectroscopic detection function and including: a laser 161; a collimator lens 162; a dichroic mirror 163 for reflecting laser light and allowing passage of fluorescence; a galvanometer mirror 164 for scanning a sample S; a pupil-projection lens 165; a tube lens 166; a mirror 167; an objective 168 for irradiating the sample S with excitation light; a multilayer filter 181; a confocal lens 169 for collecting fluorescence; a confocal stop 170 having a pinhole at the focal position of the confocal lens 169; a lens 182 for converting incident light into parallel light fluxes; a diffraction grading 183; a collector lens 184; a spectral slit 185; and a photomultiplier 173.

In the fluorescent microscope 180, the diffraction grating 183 is placed so that it can be rotated. Accordingly, the positions at which pieces of diffracted light of different wavelengths obtained via the dispersion by the diffraction grating 183 are collected change depending on the rotation angle of the diffraction grating 183. The spectral slit 185 moves depending on the wavelength range of a detected object. This enables fluorescence of any wavelength range to be detected with the photomultiplier 173.

Since the multilayer filter 181 has a cyclic film-thickness structure in which three or more layers are defined as one cycle, it can form an extremely narrow reflection band. In addition, since the multilayer filter 181 is placed in parallel light fluxes between the dichroic mirror 163 and the confocal lens 169, it indicates the most preferable spectral transmittance characteristic. This enables only laser light to be removed efficiently without blocking fluorescence.

Therefore, the fluorescent microscope 180 according to the present embodiment can efficiently remove laser light without decreasing the brightness of fluorescence images.

What is claimed is:

1. A multilayer filter comprising:
a multilayer part in which a layer composed of a first material and a layer composed of a second material having a refractive index different from that of the first material are stacked in an alternating pattern, wherein
the multilayer part has a cyclic film-thickness structure in which three or more layers are defined as one cycle.

2. The multilayer filter according to claim 1, wherein
the multilayer part has a cyclic film-thickness structure in which three layers are defined as one cycle.

3. The multilayer filter according to claim 2, wherein:
the multilayer part is a structure in which basic configurations are stacked;
the basic configurations are each composed of
a first layer having a first optical film thickness,
a second layer stacked on the first layer and having a second optical film thickness,
a third layer stacked on the second layer and having a third optical film thickness,
a fourth layer stacked on the third layer and having the first optical film thickness,
a fifth layer stacked on the fourth layer and having the second optical film thickness, and
a sixth layer stacked on the fifth layer and having the third optical film thickness; and
at least one of the first, second, and third optical film thicknesses is different from the other optical film thicknesses.

4. The multilayer filter according to claim 2, wherein
the multilayer part is a structure in which basic configurations are stacked;
the basic configurations are each composed of
a first layer having an optical film thickness within a first range,
a second layer stacked on the first layer and having an optical film thickness within a second range,
a third layer stacked on the second layer and having an optical film thickness within a third range,
a fourth layer stacked on the third layer and having an optical film thickness within the first range,
a fifth layer stacked on the fourth layer and having an optical film thickness within the second range, and
a sixth layer stacked on the fifth layer and having an optical film thickness within the third range; and
when a central value of an optical film thickness within the first range is a first optical film thickness, a central value of an optical film thickness within the second range is a second optical film thickness, and a central value of an optical film thickness within the third range is a third optical film thickness, then at least one of the first, second, and third optical film thicknesses is different from the other optical film thicknesses.

5. The multilayer filter according to claim 3, wherein
two of the first, second, and third optical film thicknesses are substantially equal to each other.

6. The multilayer filter according to claim 3, wherein
when λ indicates a standard wavelength, t1 indicates the first optical film thickness, t2 indicates the second optical film thickness, t3 indicates the third optical film thickness, and λ=4×(t1+t2+t3), then a reflection band for vertical incident light is provided proximate to the standard wavelength.

7. The multilayer filter according to claim 3, wherein
when λ indicates a standard wavelength, t1 indicates the first optical film thickness, t2 indicates the second optical film thickness, t3 indicates the third optical film thickness, and λ=4×(t1+t2++t3), then a reflection band for vertical incident light is provided proximate to a wavelength which is ⅕ the standard wavelength.

8. The multilayer filter according to claim 6, wherein
the multilayer filter is a minus filter that uses the reflection band.

9. The multilayer filter according to claim 6, wherein
the multilayer filter is a dichroic mirror that uses the reflection band.

10. The multilayer filter according to claim 1, wherein
the multilayer part has a cyclic film-thickness structure in which four layers are defined as one cycle.

11. The multilayer filter according to claim 10, wherein
the multilayer part is a structure in which basic configurations are stacked;
the basic configurations are each composed of
a first layer having a first optical film thickness,
a second layer stacked on the first layer and having a second optical film thickness,
a third layer stacked on the second layer and having a third optical film thickness, and
a fourth layer stacked on the third layer and having a fourth optical film thickness; and
at least one of the first, second, third, and fourth optical film thicknesses is different from the other optical film thicknesses.

12. The multilayer filter according to claim 10, wherein:
the multilayer part is a structure in which basic configurations are stacked;
the basic configurations are each composed of
a first layer having an optical film thickness within a first range,
a second layer stacked on the first layer and having an optical film thickness within a second range,
a third layer stacked on the second layer and having an optical film thickness within a third range, and
a fourth layer stacked on the third layer and having an optical film thickness within a fourth range; and
when a central value of an optical film thickness within the first range is a first optical film thickness, a central value of an optical film thickness within the second range is a second optical film thickness, a central value of an optical film thickness within the third range is a third optical film thickness, and a central value of an optical film thickness within the fourth range is a fourth optical film thickness, then at least one of the first, second, third, and fourth optical film thicknesses is different from the other optical film thicknesses.

13. The multilayer filter according to claim 11, wherein
when λ indicates a standard wavelength, t1 indicates the first optical film thickness, t2 indicates the second optical film thickness, t3 indicates the third optical film thickness, t4 indicates the fourth optical film thickness, and λ=2×(t1+t2+t3+t4), then a reflection band for vertical incident light is provided proximate to the standard wavelength.

14. The multilayer filter according to claim 11, wherein
when λ indicates a standard wavelength, t1 indicates the first optical film thickness, t2 indicates the second optical film thickness, t3 indicates the third optical film thickness, t4 indicates the fourth optical film thickness, and λ=2×(t1+t2++t3+t4), then a reflection band for vertical incident light is provided proximate to a wavelength ⅓ the standard wavelength.

15. The multilayer filter according to claim 13, wherein
the multilayer filter is a minus filter that uses the reflection band.

16. The multilayer filter according to claim 13, wherein
the multilayer filter is a dichroic mirror that uses the reflection band.

17. The multilayer filter according to claim 1, wherein
in a predetermined wavelength range, a difference is small between a transmittance characteristic with respect to P polarized light contained in oblique incident light and a transmittance characteristic with respect to S polarized light contained in the incident light.

18. A fluorescent microscope comprising
the multilayer filter according to claim 1.

19. The fluorescent microscope according to claim 18, wherein
the multilayer filter is placed in a detection light path.

20. The fluorescent microscope according to claim 18, wherein
the multilayer filter is placed in an illumination light path.
